(19) United States
(12) Patent Application Publication
(10) Pub. No.: US 2024/0382060 A1
(43) Pub. Date: Nov. 21, 2024

(54) FLAT MOP COVER, FLAT MOP HOLDER, MOP SYSTEM, METHOD FOR PRODUCING A FLAT MOP COVER, KIT OF PARTS, AND USE OF A FLAT MOP COVER

(71) Applicant: Hydroflex Group GmbH, Buseck (DE)

(72) Inventors: Edward Becker, Fernwald (DE); Olaf Barski, Frankfurt am Main (DE); Peter Nober, Rommersheim (DE); Maximilian Morgenstern, Mainz (DE)

(21) Appl. No.: 18/693,865

(22) PCT Filed: Sep. 21, 2022
(86) PCT No.: PCT/EP2022/076231

§ 371 Date: Mar. 20, 2024

(30) Foreign Application Priority Data
Sep. 21, 2021 (DE) 10 2021 124 438.2

(51) Int. Cl. A47L 13/256; A47L 13/257; A47L 13/42; B32B 5/02; B32B 5/18; B32B 5/24; B32B 5/26

(52) U.S. Cl. CPC A47L 13/256; A47L 13/257; A47L 13/42; B32B 5/022; B32B 5/18; B32B 5/245; B32B 5/265; B32B 2307/726; B32B 2432/00

(57) ABSTRACT

In a flat mop cover with an active side to be directed onto a surface to be cleaned and opposite thereto a rear side, transverse edges opposite one another and longitudinal edges opposite one another, wherein the longitudinal edges are longer than the transverse edges and wherein the flat mop cover has on the rear side at least two pockets opposite one another in the transverse direction for receiving a flat mop holder, which extend along the opposite longitudinal edges, it is provided that at least one of the pockets is divided by at least one bar into at least two sections, wherein the bar is adapted and arranged for fixing a predetermined position of the flat mop cover on the flat mop holder.

### BACKGROUND

### Technical Field

The present disclosure relates to a flat mop cover and a production method for a flat mop cover. The present disclosure also relates to a flat mop holder and a mop system for a flat mop cover and a kit of parts with at least one flat mop cover. According to the disclosure, the use of the flat mop cover, flat mop holder, and/or mop system is provided for the cleaning, in particular of floors, walls and/or ceilings, in preferably sterile clean rooms.

### Description of the Related Art

For the cleaning of floors or other surfaces in clean rooms, mop systems are used which carry a mop cover which is configured, for example, as a flat mop cover. The work in clean rooms is accompanied by particular hygiene requirements. This relates to the objects and work processes which can be used in clean rooms. It is of primary importance to prevent the introduction of contaminants, such as particles and/or germs, into the clean room, as well as a possible cross-contamination of clean objects by contaminants of other objects.

For mop systems and other work apparatuses which are introduced into clean rooms, it is generally the case that these must be decontaminatable and disinfectable, if appropriate even sterilizable, for example by autoclaving at 121° C. for up to 25 minutes or at 134° C. for up to 6 minutes. Likewise, the mop systems must regularly be resistant to cleaning agents, disinfectants and/or solvents. Disinfectants comprise, for example, diamines, isopropanol, ethanol, active chlorine, hydrogen peroxide. Cleaning agents comprise, for example, alkaline cleaning agents, such as sodium hydroxide, and/or acidic cleaning agents. A solvent is, for example, acetone.

A cleaning device for clean rooms in the form of a mop system which comprises a shaft part, a closure element, and a holder for a mop cover is described, for example, in DE 20 2013 011 946 U1. In the known cleaning device, a lever-like closure element is provided on the upper side of the holder for the mop cover. The holder is substantially rectangular and has a longitudinal extent which is greater than its width extent. The holder comprises two holding wings which are pivotable relative to one another. For cleaning, the closure element holds the holding wings in one plane, so that a flat mop cover can be placed flat on the lower side of the holder on a surface to be cleaned. The flat mop cover has pockets lying opposite one another in the longitudinal direction for receiving in each case one holding wing. If the closure element is released, the holding wings fold downward in the direction away from the mop handle, so that the holding wings can slide out of the pockets of the mop cover and release the mop cover. The closure element on the upper side of the holder can be actuated by the cleaning personnel. The cleaning device is well suited to ergonomic clean room cleaning and is therefore very popular.

When cleaning clean rooms, the mop cover generally must replaced after each cleaning process, i.e., a multiplicity of mop covers are often required for cleaning a room. The mop covers are usually replaced after 15-18 m², which corresponds to the respective surface area of the mop cover. Mop covers generally have a length of about 40 cm and a width of about 10 cm. Pockets, eyelets or the like for gripping and clamping the mop cover by a flat mop holder are provided along the short sides. When used in clean rooms, it is provided that a mop cover is pulled in loop form over the surface to be cleaned. Persistent dirt can be removed by rubbing, the cleaning personnel, if appropriate using body weight, exerting pressure on the mop via the mop system in order to intensify the frictional action on the active surface of the cover for removing the dirt. Known mop covers tend to deform even when driving along loop-shaped paths under frictional loading, wherein folds are formed on the active surface, which restricts the surface coverage actually achievable. As a result of a strong frictional loading, for example during a rubbing process, there is furthermore the risk of the mop cover becoming detached from the flat mop holder. A detached mop cover generally cannot be used further, which further restricts the surface area. In order to avoid cross-contamination when using mop systems, the receptacle of fresh mop covers and the discharge of used mop covers takes place without manual contact. Manual contact of the mop by cleaning personnel is disadvantageous since cross-contaminations can occur. In this case, a contamination can be transmitted from a used mop cover to a user and from a user to a fresh mop cover or other objects in the clean room. This can lead to undesired contamination of the clean room. In addition, this avoids that the cleaning personnel must bend during the receptacle and/or the discharge of a mop cover.

There is a desire for mop systems and mop covers which ensure an improved cleaning effect compared to conventional systems or covers and are easy to handle. A further desire is for the provision of an improved system and/or cover at comparable, preferably lower, costs.

Some different flat mop holders for receiving flat mop covers are described, for example, in EP 0 757 903 B1, U.S. Pat. No. 9,009,907 B2, or EP 2 055 222 B1. The flat mop holders are composed of two holding wings which are rotatable relative to one another about a pivot axis, so that the flat mop holder has an unfolded configuration, in which a flat mop cover can be pulled onto the flat mop holder, and a folded-in configuration, in which the holding wings of the flat mop holder lying against one another fix the flat mop cover. In the folded-in operating position, a connecting part for movably holding the flat mop holder on a mop handle is arranged on a longitudinal edge of the flat mop holder lying opposite the pivot axis. In the folded-in configuration, outwardly facing active surfaces of the flat mop cover are arranged on mutually opposite sides of the flat mop holder. Owing to the arrangement of the connecting part on a longitudinal edge of the flat mop holder, in conventional mop systems of this type, on the one hand the handling by cleaning personnel and on the other hand the cleaning effect on the longitudinal edge in the region of the connecting part are impaired. The fastening of the mop cover on the flat mop holder requires a multiplicity of work steps and generally does not take place without contact of the cleaning personnel with the flat mop cover, so that the mop covers described are virtually unsuitable for use in a clean room.

EP 1 843 692 B1 and EP 1 653 840 B1 describe mop systems with a mop cover, in which the connecting piece for connecting the mop holder to the mop handle is provided centrally on the mop holder. The mop cover has an active surface to be directed onto a surface to be cleaned and an opposite rear side, on which fastening means are arranged in order to hold the mop cover on the mop holder. According to EP 1 653 840 B1, the fastening means comprise a pocket on a longitudinal edge of the multilayer mop cover and a hook-and-loop connector on the opposite longitudinal edge. EP 1 843 692 B1 provides flaps at the corners of the mop cover as fastening means. The mop holders described and associated mop covers have a complex construction which is both cost-intensive in manufacture and complicated in handling.

Another flat mop holder and a flat mop cover to be clamped thereon are described in EP 1 761 156 B1. The flat mop holder is intended to allow simple handling for clamping the flat mop cover without the flat mop cover having to be contacted by the cleaning personnel during clamping or detachment from the flat mop holder. Provided centrally on the flat mop holder is a connecting piece for connecting the mop handle and a pivot joint which allows two mop holding wings to rotate relative to one another and to the connecting part about a pivot axis extending in the longitudinal direction. The flat mop cover defines a rectangular base area which is greater in the longitudinal direction than in the transverse direction. Pockets lying opposite one another are provided along the longitudinal edges of the flat mop cover, which can receive in each case one of the mop holding wings. However, it has been found that, in mop systems of this type, increased frictional resistances occur along the long longitudinal edge when treating a surface to be cleaned, as a result of which the longitudinal edge can slip, which can lead to the formation of folds or, in the worst case, to unintentional detachment of the flat mop cover from the flat mop holder, as a result of which the cleaning effect is greatly impaired.

### BRIEF SUMMARY AND INITIAL DISCLOSURE

Disclosed herein is a flat mop cover, a flat mop holder, a mop system, a kit of parts, a use method and/or a production method which allows the use of a particularly cost-effective flat mop with a high cleaning effect.

Accordingly, a flat mop cover is provided which has an active side to be directed onto a surface to be cleaned and opposite thereto a rear side. The flat mop cover further has transverse edges lying opposite one another and longitudinal edges lying opposite one another. The longitudinal edges are longer than the transverse edges. The flat mop cover preferably has a rectangular or substantially rectangular basic shape. The longitudinal and transverse edges adjacent to one another can be oriented in pairs transversely, in some cases orthogonally, to one another. The flat mop cover can have a length in the range from 30 to 60 cm, in some cases a length in the range from 40 cm to 55 cm, preferably a length in the range from 45 to 50 cm. Alternatively or additionally, the flat mop cover can have a width in the range from 5 to 30 cm, in some cases in the range from 10 to 20 cm, preferably in the range from 12 to 17 cm. Surprisingly, it has been shown that, contrary to existing prejudices, particularly large flat mop covers are suitable for use in clean rooms, in particular if they are formed with at least one bar. The expansion of a flat mop cover for example to a length in the range from 45 cm to 50 cm and a width in the range from 12 to 17 cm allows a particularly high surface coverage. Until now, such an enlarged expansion has been ruled out on account of the increase in the uncontrollable risk of crease formation and slipping associated with the enlargement. It has further been shown that even narrow regions can continue to be cleaned with the required cleaning performance, in some cases using transverse connections at a distance from the corresponding transverse edge.

The flat mop cover has, on the rear side, at least two pockets lying opposite one another in the transverse direction for receiving a flat mop holder. The pocket of the flat mop cover is adapted and arranged to receive at least one, in some cases exactly one, mop holding wing of a flat mop holder. The pocket preferably has a pocket opening directed in the direction of a central region of the flat mop cover. The pocket openings of the opposite pockets of the flat mop holder face one another. Starting from the respective longitudinal edge, a pocket has a width in the transverse direction of at least 10 mm, in some cases at least 20 mm and/or at most 50 mm, preferably at most 30 mm, in some cases approximately 25 mm. In some cases, the width of the pocket in the transverse direction is less than one third, preferably less than one quarter, or measures approximately one tenth of the width of the flat mop cover in the transverse direction.

According to the first aspect of the disclosure, it is provided that at least one of the pockets is divided by at least one bar into at least two sections, wherein the bar is adapted for fixing a predetermined position of the flat mop cover on the flat mop holder. The bar forms a fixing, in some cases in the longitudinal direction, which can be brought into engagement, for example, with a shape-corresponding receiving recess of a mop holder. Both pockets preferably each have at least one bar which divides the respective pocket into different sections. The bars and/or pockets can be arranged mirror-symmetrically with respect to one another with respect to a central axis of the flat mop cover, which can correspond to a longitudinal axis or pivot axis of the flat mop holder. The at least one bar is preferably arranged spaced apart with respect to the longitudinal edge associated with it. The distance of the bar from the longitudinal edge associated with it can be at least 5 mm, preferably at least 10 mm, in some cases approximately 12 mm in the transverse direction. The distance and/or width of the bar in the transverse direction from the longitudinal edge associated with it is preferably less than the width of the pocket in the transverse direction starting from the longitudinal edge. The distance and/or width of the bar in the transverse direction from the longitudinal edge associated with it can correspond in some cases to at least 50%, at least 75%, at least 90% or the entire width of the pocket in the transverse direction starting from the longitudinal edge. The distance and/or the width of the bar in the transverse direction from the next longitudinal edge preferably corresponds approximately to half the width of the respective pocket. It has surprisingly been found that by providing a bar in a pocket of the flat mop cover, a positioning aid or fixing can be defined in a simple, cost-effective manner, which effectively prevents a mop cover from throwing folds in the region of the longitudinal edge or even sliding off the flat mop holder even under increased friction. As a result, the cleaning effect is considerably improved compared to conventional flat mop covers without the cleaning personnel being impaired in their work or, for example during clamping or detachment, having to take into account special features of a mop cover. The mop cover can be covered with a flat mop holder in a simple manner without the cleaning personnel having to contact the mop cover.

According to one embodiment of a flat mop cover, the at least one bar is formed as a seam, in some cases a point seam. The bar-forming seam can preferably connect the mutually opposite inner sides of the flat mop cover to one another. It can be preferred that the bar-forming seam penetrates the mop cover in the region of the pocket completely from the active side to the rear side. It has in particular also been found that the introduction of the bar as a seam, in some cases a point seam, forms a precise and reliable and nevertheless simple and thus cost-effectively implementable means for realizing a fixing.

Alternatively or additionally, it is provided in one embodiment of the flat mop cover that the at least one bar, in some cases several bars, preferably exactly two bars, is or are arranged in a pocket centrally between the transverse edges of the flat mop cover. Preferably, a bar can be introduced into the pocket centrally with respect to the longitudinal axis, approximately at half the length of the flat mop cover. In one embodiment of a flat mop cover with several, preferably exactly two bars, in the same pocket, it can be preferred that the several bars are arranged mirror-symmetrically with respect to a transverse central axis, which extends in some cases transversely, preferably orthogonally to the longitudinal central axis of the mop cover and/or pivot axis of the mop holder. The distance of two bars of the same pocket from one another is in some cases less than ⅔, in some cases less than ½ the longitudinal extent of the flat mop cover. The distance of two bars of the same pocket from one another is in some cases at least ¼, in some cases at least ⅓ the longitudinal extent of the flat mop cover.

According to a further embodiment of the flat mop cover, which can be combined with the previous ones, at least one, preferably in each case one, in some cases sewn, longitudinal seam extends in the longitudinal direction along the first and/or the second longitudinal edge. The longitudinal seam can extend continuously and/or from the first transverse edge to the second transverse edge of the flat mop cover. The two opposite longitudinal edges of the flat mop cover preferably each have a longitudinal seam. The longitudinal seam preferably extends parallel to the adjacent longitudinal edge. In the transverse direction, the longitudinal seam is arranged relative to the adjacent longitudinal edge of the flat mop cover at a distance of at least the single material thickness of the flat mop cover and/or at a distance which is less than half the distance or the width of the bar in the transverse direction from the adjacent longitudinal edge. As a result of the longitudinal seam, a reinforcement of the flat mop holder along its longitudinal edges can be brought about, which counteracts slipping, creasing or other deformation which is associated with unintentional detachment.

According to a second aspect of the disclosure, which can be combined with the others, the at least one, in some cases sewn, transverse connection is formed in the transverse direction, in some cases at least in the region of the pockets and/or at least in the region of the active surface, along the first and/or the second transverse edge. The transverse seam preferably does not fasten the flaps to the active surface. In some cases, the transverse connection extends, preferably continuously, from the first longitudinal edge to the second longitudinal edge. Alternatively, the transverse connection can comprise at least 2, in some cases more than 2, for example 3, 4, 5 or more, point connections spaced apart from one another in the transverse direction, wherein the point connections, in some cases point seams, of the transverse connection are preferably arranged on the same straight line, wherein the straight line preferably extends parallel to the transverse edge. It should be clear that the flat mop holder can be provided on each pocket with transverse connections lying opposite one another in the longitudinal direction and at least one additional bar, wherein the bar differs from the transverse connections and/or the bar is arranged in the longitudinal direction between the transverse connections lying opposite one another. Starting from the adjacent longitudinal edge, the width of at least one transverse connection is greater than the width or the distance of a bar associated with the same pocket. As a result of the transverse connections on the transverse edge of the mop cover, the transverse edge is given a defined fold, along which lateral flaps can pivot upward. The transverse connections on the transverse edge of the mop cover thus allow, in some cases in the case of an arrangement at a known distance from the transverse edge, a particularly thorough cleaning performance even during a wiping movement in the longitudinal direction, which is advantageous for example for cleaning narrow gaps and/or grooves, for example at a transition between a horizontal base surface and a vertical wall surface, in a clean room and results in an increase in the effective surface coverage.

Also in the second aspect, a flat mop cover can be provided which has an active side to be directed onto a surface to be cleaned and opposite thereto a rear side. The flat mop cover further has transverse edges lying opposite one another and longitudinal edges lying opposite one another. The longitudinal edges are longer than the transverse edges. The flat mop cover preferably has a rectangular or substantially rectangular basic shape. The longitudinal and transverse edges adjacent to one another can be oriented in pairs transversely, in some cases orthogonally, to one another. The flat mop cover can have a length and/or a width in the above-described range. Furthermore, according to the second aspect, the flat mop cover has, on the rear side, at least two pockets lying opposite one another in the transverse direction for receiving a flat mop holder. The pocket of the flat mop cover is adapted and arranged to receive at least one, in some cases exactly one, mop holding wing of a flat mop holder. The pocket preferably has a pocket opening directed in the direction of a central region of the flat mop cover. The pocket openings of the opposite pockets of the flat mop holder face one another. Starting from the respective longitudinal edge, a pocket has a width in the transverse direction as described above.

According to a further development of the flat mop cover, the at least one transverse connection is arranged at a distance from the corresponding (adjacent) transverse edge of at least 5 mm, in some cases at least 10 mm, and/or at most 50 mm, in some cases at most 25 mm, preferably approximately 15 mm. The longitudinal distance of the transverse connection from the adjacent transverse edge is preferably not greater than the transverse width of the corresponding pocket. The longitudinal distance of the transverse connection from the adjacent transverse edge can correspond approximately to the transverse width or the transverse distance of the bar from the adjacent longitudinal edge. In the distance between the transverse connection and the corresponding (adjacent) transverse edge, a connection of the opposite flaps to one another, for example by way of a preferably textile ribbon, and/or a connection of the flaps to the active surfaces, for example by way of a layer connection, can be provided.

According to one embodiment of the flat mop cover, which can be combined with the previous ones, the transverse edge is formed as a free edge, in some cases by a cutting edge, preferably by way of heat, laser and/or ultrasonic cutting. The transverse edge is preferably realized by coves lying opposite one another in the transverse direction in the region of the longitudinal edges forming pockets. The transverse edge is preferably formed with a sealing of the textile material of the flat mop cover. It has surprisingly been shown that the cleaning effect of a flat mop cover with a free transverse edge clearly exceeds all expectations. Contrary to the general teaching that, in some cases in the clean room sector, work apparatuses such as cleaning apparatuses including flat mop covers should be formed as free as possible of undercuts which are generally regarded as dirt trapping to be avoided, it has been shown that a flat mop cover with free transverse edges enables particularly good cleaning results. The free transverse edge supplements the region of the mop holder stiffened by the mop holder in the longitudinal direction by a flexible region which is particularly well suited to trapping dirt in corners which are difficult to access. In addition, the free transverse edge, which is usually inclined or erected toward the rear side, forms an effective shielding of the transverse edges of a flat mop holder received in the flat mop cover.

According to an additional aspect of the disclosure, which can realize an embodiment of a flat mop cover as described above, this flat mop cover comprises exactly two or at least two layers which are connected, in some cases sewn, to one another at least at points. The additional aspect of the disclosure can preferably be combined with the first, second and/or third aspect of the disclosure. According to the additional independent aspect of the disclosure, the flat mop cover can be realized with at least one layer connection and without a transverse connection realized as described above and/or without a bar realized as described above. The multi-layer flat mop cover comprises a cleaning layer adapted and arranged for cleaning a surface and a cover sheet layer which is adapted and arranged for bringing into contact with the flat mop holder. In some cases, the cover sheet layer forms the mutually opposite inner sides of a respective pocket. A pocket can generally be formed by a flap which is not folded along an edge, in some cases the longitudinal edge, of a material web. The fold of the flap can define the edge, in some cases the longitudinal edge, of the mop cover. A first layer connection, in some cases a first connecting seam, is preferably provided in the region of the flap crease. The outer sides of the pocket are preferably formed by the cleaning layer and the inner side of the pocket are formed by the cover sheet layer. The layer connection optionally penetrates the two mutually opposite pocket regions of the cover sheet layer.

In some cases, the layer connection has at least one rectilinear connecting seam, in some cases two preferably parallel rectilinear connecting seams, in a central region with respect to the transverse direction. The at least one rectilinear connecting seam is preferably oriented parallel to the longitudinal edge of the flat mop cover. Alternatively or additionally, the layer connection has at least two connecting seams which are at least in sections oblique or wave-shaped, in some cases zigzag-shaped, which extend from the longitudinal edge into the central region with respect to the transverse direction. In a particularly preferred embodiment, the flat mop cover has two preferably mirror-symmetrically opposite wave-shaped, in some cases zigzag-shaped, connecting seams which are preferably inclined with respect to the longitudinal direction by 30° to 60°, particularly preferably by 45°. Surprisingly, it has been found that wave-shaped, in some cases zigzag-shaped, connecting seams which penetrate the active side of the flat mop holder support the wiping performance of the flat mop cover. With the aid of oblique connecting seams which extend from the longitudinal edge to the central region, a particularly homogeneous dirt pick-up can surprisingly be achieved over the entire region of the active surface of the flat mop cover. Unlike in conventional flat mop covers, according to the additional aspect of the disclosure, dirt pick-up by the flat mop cover is not concentrated in the region of the longitudinal edge, but is distributed substantially uniformly over the active surface of the flat mop cover spanned by the active side. The dirt pick-up in the central region of the flat mop cover is thereby substantially the same as in the region of the longitudinal edge. A greater surface wiping coverage can thus be achieved with an equally large flat mop cover with the aid of the additional aspect of the disclosure.

The central region extends in the transverse direction between the opposite pockets. The central region is preferably less than 75%, preferably less than 50%, of the distance between the opposite pockets in the transverse direction. The central region preferably extends over a large part of the longitudinal extent of the flat mop cover or over the entire longitudinal extent of the flat mop cover. In the central region, the rear side of the flat mop holder is preferably free of pockets. The central region is preferably not greater than 75%, in some cases not greater than 60%, and/or at least as large as 30%, preferably at least as large as 50%, of the transverse width of the flat mop cover. The layer connections are preferably arranged at least partially in a central region of the flat mop cover which is less than the distance between the wing edges, in some cases wing longitudinal edges, of a flat mop holder, for example of the flat mop holder described below, provided for insertion into the pockets, in a release position of the mop holding wings. In this way, it can be ensured that the connecting seams in the central region do not interfere with or even support the insertion of the mop holding wings into the pockets of the flat mop cover.

In a preferred embodiment of the additional aspect of the disclosure, the flat mop cover has exactly three or at least three layers which are connected, in some cases sewn, to one another at least at points. The three layers can be connected to one another for example by a thermal joining method. The three layers comprise on the one hand a cleaning layer adapted and arranged for cleaning a surface and on the other hand a cover sheet layer which is adapted and arranged for bringing into contact with the flat mop holder. In some cases, the cover sheet layer forms the inner sides of the pockets. As a further layer, the flat mop cover according to the additional aspect of the disclosure comprises at least one, in some cases exactly one, exactly 2 or exactly 3 intermediate layer(s) arranged between the cleaning layer and the cover sheet layer. The at least one intermediate layer expediently has a water pick-up capacity of at least 10 ml/g (volume of the received water in relation to the weight of the intermediate layer). It can be preferred that the intermediate layer has a water pick-up capacity of at least 16 ml/g, in some cases at least 22 ml/g. The water pick-up capacity can be related to distilled water as a reference variable. The intermediate layer can preferably have a grammage in the range from 200 to 300 g/m², in some cases about 240 g/m². It can be preferred that the nonwoven material for forming the intermediate layer has a thickness in the unloaded state of at least 3 mm, in some cases at least 5 mm, preferably at least 7 mm and/or not more than 25.4 mm, in some cases not more than 13 mm, preferably not more than 10 mm. Alternatively or additionally, the intermediate layer is formed from an, in some cases unconsolidated, nonwoven material or from a foam material. To form the pockets, it can be preferred to fold over the cleaning layer along the longitudinal or transverse edges onto the rear side of the flat mop cover. A cover sheet layer of the flat mop cover with the same dimensions as the cleaning layer is likewise folded over here and thus forms the inner surfaces of the mop cover with which the flat mop holder is in touch contact. The cover layer provides a particular wear resistance for the flat mop cover in order to prevent damage to the intermediate layer and the cleaning layer. If the cleaning personnel exerts force on the flat mop cover by way of the mop system in order to increase the cleaning effect, if appropriate using body weight, the material layers are pressed together between the surface to be cleaned and the mop system. As a result, water or cleaning liquid can be released in a targeted manner from the intermediate layer. As a result, the surface coverage achievable with the mop cover can be increased.

In a third aspect of the disclosure, a flat mop cover is provided which has an active side to be directed onto a surface to be cleaned and opposite thereto a rear side. The flat mop cover further has transverse edges lying opposite one another and longitudinal edges lying opposite one another. The longitudinal edges are longer than the transverse edges. The flat mop cover preferably has a rectangular or substantially rectangular basic shape. The longitudinal and transverse edges adjacent to one another can be oriented in pairs transversely, in some cases orthogonally, to one another.

According to the third aspect of the disclosure, the flat mop cover has, on the rear side, at least two pockets lying opposite one another, in some cases in the transverse direction or longitudinal direction, for receiving a flat mop holder. The pocket of the flat mop cover is adapted and arranged to receive at least one, in some cases exactly one, mop holding wing of a flat mop holder. The pocket preferably has a pocket opening directed in the direction of a central region of the flat mop cover. The pocket openings of the opposite pockets of the flat mop holder face one another. Starting from the respective longitudinal edge, a pocket has a width in the transverse direction of at least 10 mm, in some cases at least 20 mm and/or at most 50 mm, preferably at most 30 mm, in some cases approximately 25 mm. In some cases, the width of the pocket in the transverse direction is less than one third, preferably less than one quarter, or measures approximately one tenth of the width of the flat mop cover in the transverse direction.

According to the third aspect of the disclosure, the flat mop cover has exactly three or at least three layers which are connected, in some cases sewn, to one another at least at points. The three layers can be connected to one another for example by a thermal joining method. The three layers comprise on the one hand a cleaning layer adapted and arranged for cleaning a surface and on the other hand a cover sheet layer which is adapted and arranged for bringing into contact with the flat mop holder. In some cases, the cover sheet layer forms the inner sides of the pockets. As a further layer, the flat mop cover according to the third aspect of the disclosure comprises at least one, in some cases exactly one, exactly 2 or exactly 3 intermediate layer arranged between the cleaning layer and the cover sheet layer. The at least one intermediate layer expediently has a water pick-up capacity of at least 10 ml/g (volume of the received water in relation to the weight of the intermediate layer). It can be preferred that the intermediate layer has a water pick-up capacity of at least 16 ml/g, in some cases at least 22 ml/g. The water pick-up capacity can be related to distilled water as a reference variable. The intermediate layer can preferably have a grammage in the range from 200 to 300 g/m², in some cases about 240 g/m². It can be preferred that the nonwoven material for forming the intermediate layer has a thickness in the unloaded state of at least 3 mm, in some cases at least 5 mm, preferably at least 7 mm and/or not more than 25.4 mm, in some cases not more than 13 mm, preferably not more than 10 mm. Alternatively or additionally, the intermediate layer is formed from an, in some cases unconsolidated, nonwoven material or from a foam material. To form the pockets, it can be preferred to fold over the cleaning layer along the longitudinal or transverse edges onto the rear side of the flat mop cover. A cover sheet layer of the flat mop cover with the same dimensions as the cleaning layer is likewise folded over here and thus forms the inner surfaces of the mop cover with which the flat mop holder is in touch contact. The cover layer provides a particular wear resistance for the flat mop cover in order to prevent damage to the intermediate layer and the cleaning layer. If the cleaning personnel exerts force on the flat mop cover by way of the mop system in order to increase the cleaning effect, if appropriate using body weight, the material layers are pressed together between the surface to be cleaned and the mop system. As a result, water or cleaning liquid, respectively, can be released in a targeted manner from the intermediate layer. As a result, the surface coverage achievable with the mop cover can be increased.

According to a further development of the flat mop cover according to the third aspect of the disclosure, the pockets on the rear side of the flat mop cover each comprise at least one flap. The flaps are preferably free of the intermediate layer between the cleaning layer and the cover sheet layer. In some cases, flaps lying opposite in the transverse direction are connected to an, in some cases textile, ribbon and/or wherein the flaps are connected to the active surface in a region between the transverse edge and the transverse connection adjacent thereto. The ribbon is preferably fastened on the inside to the flap or pocket in order to be protected against fraying. In the case of a flat mop cover with a rectangular base area, the active side is formed by the cleaning layer directed onto the surface to be cleaned. The intermediate layer is arranged, in some cases exclusively, in the region of the flat mop cover arranged between the mop system, in some cases the flat mop holder lower side, and the surface to be cleaned. In the region of the flaps on the rear side of the flat mop cover and thus on the upper side of the mop holder, not in touch contact with the surface to be cleaned, preferably no intermediate layer with a high water pick-up capacity is arranged. In the region of the flaps above the flat mop holder, the cleaning personnel cannot readily achieve an effective wringing effect. Since flat mop covers are generally stored as stacked goods, it is additionally advantageous to dispense with an intermediate layer in the region of the flaps in order to avoid unnecessarily high and increasingly deformed stacks.

According to a further development of a flat mop cover, the cleaning layer can be an unconsolidated cleaning layer. The cleaning layer can comprise or consist of a woven, knitted or crocheted layer. Additionally or alternatively, the cleaning layer comprises a microfiber material or consists of a microfiber material, wherein the microfiber material is in some cases selected from the group consisting of polyamide microfibers, polyolefin microfibers, in some cases polypropylene microfibers, polyester microfibers, in some cases polyethylene terephthalate microfibers, and split conjugated microfibers, in some cases polyamide/polyester microfibers, and any mixtures thereof.

According to a further development of a flat mop cover, which can be combined with the previous one, the cover sheet layer comprises a liquid-permeable nonwoven material, in some cases a consolidated nonwoven material. The nonwoven material of the cover sheet layer can preferably be consolidated by the action of heat and/or without the action of compressing pressure. Furthermore, a consolidated nonwoven material can be obtained by water jet treatment and/or calendering. The consolidated nonwoven materials used are, for example, consolidated spunbonded nonwovens, in some cases spunbonded nonwovens consolidated according to one of the preceding methods. Spunbonded nonwovens are generally obtained from fibers which are spun from polymer melts passing through nozzles and are stretched by way of cold air and/or mechanically. These fibers are then generally formed directly into a spunbonded nonwoven or form this spunbonded nonwoven after consolidation. Spunbonded nonwovens generally originate from continuous fibers.

In another further development, which can be combined with the previous ones, the flat mop cover has at least one, in some cases exactly one, exactly 2 or exactly 3 intermediate layer arranged between the cleaning layer and the cover sheet layer. In some cases, the at least one intermediate layer has a water pick-up capacity of at least 10 ml/g, wherein in some cases the water pick-up capacity of the intermediate layer is greater than, in some cases at least twice as large as, preferably at least 10 times as large as, in some cases at least 100 times as large as, the water pick-up capacity of the cover sheet layer. The water pick-up capacity is preferably defined as a volume of liquid, in some cases water, preferably distilled water, related to a weight of a layer. The water pick-up capacity is at least 16 ml/g, in some cases at least 20 ml/g, preferably at least 22 ml/g. Alternatively or additionally, the at least one intermediate layer can be formed from a, in some cases unconsolidated, nonwoven material or from a foam material. In a flat mop cover with two or more intermediate layers, the several intermediate layers can be identical or different. Unconsolidated nonwoven material within the meaning of the present disclosure comprises, for example, that which is obtained directly during the nonwoven production.

In a further embodiment, the intermediate layer preferably has a needle nonwoven as nonwoven material or consists thereof. In some cases, the intermediate layer is single-layered. The intermediate layer preferably has a grammage in the range from 200 g/m² to 300 g/m², in some cases 240 g/m². By using an intermediate layer with a high water pick-up capacity, a greatly increased surface coverage can be achieved compared to conventional flat mop covers.

According to a further development, the intermediate layer has a water release capacity of at least 75%, in some cases at least 90%, preferably at least 95% of the water pick-up capacity. The water release capacity can be at least 8 ml/g or at least 14 ml/g, in some cases at least 16 ml/g, preferably at least 20 ml/g. With water release capacity, the ability of the mop cover or its intermediate layer to effectively provide a received liquid for cleaning is described. Many absorbent materials with a high water pick-up capacity do not have a water release capacity adequate for cleaning purposes.

Alternatively or additionally (in some cases with respect to the third and the additional aspect of the disclosure), the at least two layers are connected to one another in some cases by at least one layer connection, in some cases at least one seam, which extends from the rear side to the active side. In this case, the at least one layer connection can penetrate the cleaning layer and/or the cover sheet layer twice in the region of the at least one pocket. In addition, the layer connection preferably penetrates the cleaning layer arranged on the rear side on the mop cover and forming the outer side of the flap or pocket, respectively. Furthermore, the layer connection can additionally penetrate the cleaning layer of the mop cover, which defines the active-side outer side of the pocket or the active surface of the flat mop cover, respectively. The layer connection can be formed, for example, by a multiplicity of point layer connections, in some cases point seams, distributed over the entire area over the transverse width and/or longitudinal extent of the mop cover. Alternatively or additionally, the layer connection can be formed or reinforced by at least one bar and/or at least one longitudinal seam adjacent to a longitudinal edge of the mop cover. It can be preferred that the transverse connection, in some cases the transverse seam, does not penetrate the cleaning layer and/or the cover sheet layer twice in the region of the at least one pocket. In other words, it can be preferred that the transverse connection does not fix the pocket to the active surface.

According to a further aspect of the disclosure, a flat mop holder for clamping a flat mop cover is provided. The flat mop cover can be realized in particular as described above. The flat mop holder has an upper side, on which a connecting piece is arranged or can be arranged, which is adapted and arranged to connect the flat mop holder to a mop handle. A mop handle can have at least one grip section, in some cases two grip sections for gripping a mop system by cleaning personnel. The flat mop holder further has a lower side lying opposite the upper side, in some cases facing or being capable to be faced towards an active side of the mop cover. The flat mop holder comprises a first mop holding wing and a second mop holding wing. The mop holding wings preferably each have a wing upper side and a wing lower side. The mop holding wings have two opposite transverse edges and two opposite longitudinal edges, wherein in each case an outer longitudinal edge faces away from the other mop holding wing. The mop holding wings can in some cases have inner longitudinal edges, which face towards one another. The longitudinal edges of a mop holding wing are longer than the transverse edges thereof. The longitudinal extent of the longitudinal edges of the mop holder is preferably greater than the transverse width of the mop holder. The transverse width of the mop holder can be defined by the cumulative transverse width of the transverse edge of the first mop holding wing and the transverse edge of the second mop holding wing. The mop holder and/or the mop holding wings preferably have a substantially rectangular basic shape. The longitudinal extent of the flat mop holder can correspond to the respective longitudinal extent of the first and/or the second mop holding wing. The longitudinal extent of the mop holder can lie in the range from 40 to 55 cm, in some cases in the range from 45 to 50 cm, preferably at approximately 48 cm. Additionally or alternatively, the width of the mop holder can lie in the range from 10 to 20 cm, in some cases in the range from 12 to 17 cm, preferably at approximately 14.5 cm. At least one of the two mop holding wings is movable relative to the other mop holding wing. The second mop holding wing can preferably be movable relative to the first mop holding wing and a connecting piece fastened or fastenable to the first mop holding wing. It can be preferred that one of the mop holding wings, in some cases the second mop holding wing, is pivotable relative to the other mop holding wing about a longitudinal axis of the flat mop holder.

According to the further aspect of the disclosure, at least one of the two mop holding wings, preferably the first mop holding wing and/or the second mop holding wing, has, on its outer longitudinal edge, at least one receptacle or recess for receiving a fixing of the flat mop cover. The mop holding wing can preferably have along its outer longitudinal edge at least one recess for receiving at least one corresponding bar of an above-described flat mop cover according to the disclosure. According to the second aspect of the disclosure, a flat mop holder is provided which has an at least sectionally shape-adapted contour with at least one receptacle of the at least one fixing of a mop cover, so that the flat mop cover to be carried on the flat mop holder can be clamped on the flat mop holder according to a predetermined position. The transverse width of the at least one recess is preferably less than half, in some cases less than one third, preferably less than one quarter of the transverse width of the flat mop holder (in its operating position). Particularly preferably, the transverse width of the at least one recess can correspond approximately to one tenth of the transverse width of the flat mop holder. Preferably, a recess can be introduced into the pocket centrally with respect to the longitudinal axis, approximately at half the length of the flat mop cover. By equipping the flat mop holder with at least one receptacle for a fixing of a corresponding flat mop cover, a reliable holding of a flat mop cover on the flat mop holder can be ensured in a particularly simple and thus cost-effective manner. By the receptacle for the fixing being arranged on at least one longitudinal edge of the flat mop holder, in some cases on at least one longitudinal edge which is movable, preferably pivotable, relative to the opposite holding wing, it can be ensured that the handling of the flat mop holder is not impaired compared to a conventional flat mop holder.

According to one embodiment of a flat mop holder, at the at least one outer longitudinal edge, in some cases at both outer longitudinal edges, respectively two or exactly two recesses are arranged. In one embodiment of a flat mop holder with several, preferably exactly two recesses, on the same mop holding wing, it can be preferred that the several recesses are arranged mirror-symmetrically with respect to a transverse central axis, which extends in some cases transversely, preferably orthogonally, to the longitudinal central axis and/or pivot axis of the mop holder. By the use of several recesses, which can preferably be arranged in the longitudinal direction on both sides of the connecting piece, a particularly favorable introduction of force from the flat mop holder into the flat mop cover can be brought about, which ensures a precise fixing of the flat mop cover on the mop holder even in the case of a pronounced static friction load on the active surface of the flat mop cover.

Another aspect of the disclosure relates to a flat mop holder for clamping a flat mop cover, which can be combined with the other aspects and embodiments. The flat mop holder comprises an upper side, on which a connecting piece is arranged or can be arranged, which is adapted and arranged to connect the flat mop holder to a mop handle. Furthermore, the flat mop holder comprises a lower side lying opposite the upper side, in some cases facing or being capable to be faced towards an active side of the mop cover. The flat mop holder comprises a first and a second mop holding wing with in each case two opposite transverse edges, at least one of the 2 mop holding wings is movable in transverse direction relative to the other mop holding wing. Essentially, the above applies. According to the other aspect of the disclosure, it is further provided that at least one of the holding wings has on the upper side at least one reinforcing structure, which is adapted and arranged to adjust the stiffness of the at least one holding wing. An otherwise structurally identical holding wing without the reinforcing structure regularly has a lower stiffness, for example with respect to bending relative to a longitudinal direction axis, with respect to bending relative to a transverse direction axis and/or with respect to torsion. The reinforcing structure can significantly increase the surface moment of inertia of the holding wing, in some cases relative to the longitudinal direction axis and/or relative to the transverse direction axis.

According to another embodiment of a flat mop holder, which can be combined with the previous ones, the reinforcing structure comprises at least one curvature inclined along the outer longitudinal edge of at least one holding wing, in some cases along the outer longitudinal edge of both holding wings, towards the upper side. The at least one recess can be formed in the curvature. The curvature can extend upwards (i.e., in the direction away from the active surface) starting from a flat portion of the holding wing, in some cases rounded. The curvature can form, in some cases directly along the longitudinal edge at least in sections, a planar plane which lies at an angle relative to the flat section. Starting from the longitudinal edge, the curvature expediently has an extent in the transverse direction of not more than 30 mm, in some cases not more than 20 mm, and/or at least 3 mm, in some cases at least 5 mm or at least 8 mm. The curvature preferably extends along the large part of the longitudinal edge, in some cases over at least 75%, preferably over at least 85%. In some cases, the at least one recess extends in the transverse direction through the curvature into a flat section of the holding wing lying behind it in the transverse direction. With the aid of an upwardly inclined curvature on the outer longitudinal edge of a flat mop cover, it can be brought about that a tensile stress is impressed on the flat mop cover in the transverse direction in an operating position of the mop holding wings, so that in some cases the active surface of the flat mop cover is pulled smooth, so that it can develop an optimum cleaning effect. Additionally or alternatively, with the aid of an upwardly inclined curvature along a longitudinal edge of the flat mop cover, a crease extending along a longitudinal edge of the flat mop cover corresponding to the longitudinal edge and/or a longitudinal seam can be fixed in a well-defined position.

In one embodiment of the flat mop holder, at least one of the holding wings, in some cases both of the holding wings, can have a reinforcing structure in the form of a longitudinal rib, in some cases curved convexly towards the upper side. In some cases, the at least one longitudinal rib extends from the flat section to the upper side. Relative to the at least one longitudinal rib, flat sections of the holding wing can be provided on both sides in the transverse direction. The longitudinal rib can extend in the longitudinal direction along the entire longitudinal extent of the respective mop holding wing. By providing one or more ribs, an increased stiffness of the flat mop holder can be brought about, and thus a more precise positioning of the flat mop cover for an improved cleaning effect.

Alternatively or additionally, it can be provided in one embodiment of the flat mop holder that the holding wings each have at least one reinforcing structure in the form of an elevation, in some cases arranged on a transverse edge, projecting in the direction of the upper side, such as a transverse rib. The flat mop holder can have at least one, in some cases two, transverse ribs and at least one longitudinal rib. A transverse rib can be formed, for example, as a rib projecting vertically upward, i.e., in the direction of the rear side, with respect to the flat section. For example, the transverse rib can be formed as part of a fiber-reinforced structure which, in functional union, forms the flat section and optionally a longitudinal rib and/or a curvature. It is conceivable that flat section and transverse ribs in one embodiment of the mop holding wing are formed from a metal sheet by bending an edge of the metal sheet by approximately 90° relative to the flat section in order to form the transverse rib.

In another embodiment of a flat mop holder, which can be combined with the previous ones, at least one of the holding wings, in some cases both holding wings, has a flattened and/or rounded corner between the outer longitudinal edge and at least one, in some cases both respectively adjacent transverse edges. The flattening and/or rounding of the corner between the outer longitudinal edge and one or both adjacent transverse edges simplifies the insertion of a mop holding wing into a corresponding mop holder longitudinal pocket, such that the mop holder can slide into the at least one pocket of the flat mop cover without hindrance even in the case of slight faulty retention of the flat mop cover relative to a fresh flat mop cover. The flattening and/or rounding of the corner brings about a guiding of the mop holding wing into the corresponding pocket, such that the at least one recess is guided toward the corresponding at least one fixing, in some cases the at least one bar, in the pocket of the mop holding wing. The handling of the mop system is thereby simplified.

Alternatively or additionally, in one embodiment of the flat mop holder, the mop holding wings are connected to one another with a pivot joint at their inner longitudinal edges so as to be movable relative to one another in such a way that the mop holding wings can be pivoted between a first position (operating position) and a second position. The pivot joint can be referred to as a primary pivot bearing. In some cases, the mop holding wings are oriented in a plane in the first position, preferably substantially planar. In the second position (release position), the mop holding wings are oriented at an angle to one another. It is conceivable that a connecting piece is equipped with a bearing, so that both mop holding wings are pivotable relative to one another and relative to the connecting piece. Alternatively, the connecting piece can be rigidly fastened to one mop holding wing, in some cases the first mop holding wing, and the other, in some cases second, mop holding wing can be pivotable relative to the connecting piece and the, in some cases first, mop holding wing. The first position can be referred to as the operating position or wiping position and the second position as the release position. The flat mop holder is preferably adapted and arranged to hold the flat mop cover in a predetermined planar configuration in the operating position. The outer longitudinal edges of the flat mop holder are preferably located at a maximum distance from one another in the transverse direction in the operating position. Alternatively or additionally, the flat mop holder can be adapted and arranged to be able to be loaded with a fresh flat mop cover in the release position and/or to release, for example to throw off, a used flat mop cover, wherein in some cases in the release position a used flat mop cover slides down from the flat mop holder under the action of gravity by its own weight. The outer longitudinal edges of the flat mop holder are preferably located at a distance from one another in the release position which is less than the maximum distance, preferably at a minimum distance in the transverse direction.

According to a further development of a flat mop holder, the pivot joint comprises a base which is fastened to a base portion of a first mop holding wing. In some cases, the base portion can project from the inner longitudinal edge in the transverse direction, preferably beyond the pivot axis. A base fastened to the first mop holding wing can ensure a particularly favorable introduction of force for the use of the mop system and enables a particularly simple construction which manages with few parts.

Furthermore, according to a further development of a flat mop holder, the pivot joint can have at least one wedge, in some cases two wedges lying opposite one another in the longitudinal direction, by way of which the pivot joint is fastened to the second mop holding wing. The at least one wedge is mounted on the base so as to be rotatable about the pivot axis. In some cases, the base and the wedge are coordinated with one another in such a way that the wedge is supported on the base in the first position in the transverse direction. The wedge can extend in the transverse direction over at least half, in some cases more than half, of the second flat mop holder. By the use of at least one wedge, a particularly favorable introduction of force into both holding wings of the flat mop holder can be ensured in the flat mop holder.

In a further development of a flat mop holder, a releasable locking mechanism, in some cases spring-preloaded, holds the wedge in the first position (operating position) in a stationary manner relative to the base. The locking mechanism can comprise a form-fitting connection and/or a magnetic connection. A form-fitting connection can have, for example, a locking pin and a locking receptacle corresponding thereto, for example a locking pin held parallel to the pivot axis in the base and movable in a translatory manner with respect to the longitudinal axis, wherein the at least one base has a locking receptacle corresponding to the locking pin. The locking pin is movable from a locking position, in which the locking pin cooperates in a form-fitting manner with the locking receptacle, into a release position, for example in a translatory manner parallel to the pivot axis. A magnetic connection can be equipped, for example, with a first holding partner, in some cases held on the base, and a second holding partner, in some cases fastened in a stationary manner to the wedge. The first and the second holding partner can both be magnetic, or one can be magnetic and the other can be magnetizable. The first holding partner is movable from a locking position, in which the holding partners form a magnetic force fit, into a release position, for example transversely to the pivot axis.

In one embodiment of the flat mop holder, the holding wings each have at least one reinforcing structure, in some cases arranged on a transverse edge, in the form of an elevation, such as a transverse rib, projecting in the direction of the upper side, wherein the elevation of the first holding wing and the elevation of the second holding wing are connected by way of a hinge, which is rotatable about the pivot axis. The hinge can be referred to as a secondary pivot bearing. The flat mop holder preferably has two hinges lying opposite one another in the longitudinal direction, in some cases arranged on the opposite transverse edges, spaced apart from the pivot bearing in the longitudinal direction, coaxial with respect to the pivot axis. By providing additional secondary pivot bearings in addition to the primary pivot bearing, an increased stiffness of the flat mop holder can be brought about, and thus a more precise positioning of the flat mop cover for an improved cleaning effect.

In a preferred embodiment of the flat mop holder, at least one, in some cases both, of the holding wings comprise or consist of plastic, in some cases fiber-reinforced plastic, preferably carbon fiber-reinforced plastic. The holding wing or wings can preferably be formed predominantly from plastic, in some cases fiber-reinforced plastic, preferably carbon fiber-reinforced plastic. The mop holder expediently has a weight of at most 450 g, in some cases at most 300 g, preferably at most 200 g or at most 150 g. In some cases, the mop holder comprises at least 50%, preferably at least 60%, particularly preferably 80%±5%, of fiber-reinforced plastic, in some cases with respect to the surface of the mop holder, preferably to the surface of the side of the mop holder to be directed onto the floor. It should be clear that the proportion of fiber-reinforced plastic of the mop holder does not take into account any connecting piece realized in some cases by an articulated connection for connecting the mop holder and the mop handle to one another. Additionally or alternatively, the at least one, in some cases both, of the holding wings can comprise or consist of stainless steel.

The plastic fiber-reinforced and/or carbon fiber-reinforced plastic comprises or consists of a matrix material and a fiber material. The matrix material comprises or consists of thermosetting plastics and/or thermoplastics, in some cases epoxy resins, polyester resins, vinyl ester resins or mixtures thereof. The fiber material comprises or consists of aramid fibers and/or carbon fibers, in some cases carbon nanotubes. The (plastic) fiber-reinforced and/or carbon fiber-reinforced plastic can have a density in the range from 1.5 to 1.6 g/cm³, in some cases in the range from 1.53 to 1.58 g/cm³, preferably approximately 1.55 g/cm³. The flat mop holder and/or other components of the mop system can each be manufactured, for example, by hand lamination, in some cases in combination with vacuum pressing, autoclave methods, injection methods, in some cases resin transfer molding or reaction injection molding, winding methods or pressing methods, in some cases hot pressing methods, wet pressing methods or prepreg methods. In some cases, the flat mop holder and/or another component of the mop system which comprises or consists of plastic fiber-reinforced and/or carbon fiber-reinforced plastic can have a wall thickness in the range from 0.01 mm to 3 mm, preferably a wall thickness of at most 1 mm, more preferably at most 0.5 mm, particularly preferably less than 0.3 mm. In some cases, the carbon fiber-reinforced plastic comprises at least 50% carbon fiber, preferably between 60% and 80% carbon fiber, particularly preferably approximately 70% carbon fiber, and/or not more than 50% matrix material, preferably between 20% and 40% matrix material, particularly preferably approximately 30% matrix material. It can be preferred that the fiber-reinforced plastic has a twill fabric, in some cases a 2×2 twill fabric, such as a 3 k woven 2×2. The fiber material can preferably have a fiber diameter of not more than 0.5 mm, preferably not more than 0.3 mm, particularly preferably a fiber diameter of 0.2 mm, and/or a fiber diameter of at least 0.1 mm. The fiber-reinforced plastic material, in some cases the carbon fiber-reinforced plastic material, can be formed in some cases from a prepreg material in the form of (carbon) fiber sheets. The prepreg material can have unidirectional fiber layers. The prepreg material can comprise prepreg fabric layers. In some cases, a prepreg material layer has a thickness of at least 0.03 mm, preferably at least 0.075 mm, and/or not more than 0.3 mm, preferably not more than 0.2 mm or not more than 0.15 mm. The (carbon) fiber material is formed from at least one prepreg material layer, in some cases at least two prepreg material layers, and/or not more than 15 prepreg material layers, preferably not more than 11 prepreg material layers, particularly preferably not more than four prepreg material layers.

According to one embodiment of a flat mop holder, at least one, in some cases both, of the holding wings has at least one recess, preferably a plurality of recesses, which is completely surrounded on the mop holding wing in the transverse direction and longitudinal direction, in some cases by a flat section of the mop holding wing. By providing recesses which penetrate at least one mop holding wing, a particularly weight-saving flat mop holder can be realized without significant losses in stiffness having to be accepted. The handling of the mop system is thereby improved.

According to the disclosure, a mop system for cleaning clean rooms can also be provided which comprises an above-described mop holder and an in some cases telescopic mop handle and a connecting piece, such as a pivot-tilt joint, wherein the connecting piece preferably detachably connects the mop handle to the mop holder, in some cases detachably without tools. So-called large wipers, for example, which are designed for cleaning large-area rooms, such as airport halls, are unsuitable for clean rooms. Large wipers of this type are not suitable for implementing the work processes provided for clean rooms, in particular standardized work processes. They are, for example, unsuitable for treating the floor in loop-shaped paths and too unwieldy for cleaning narrow regions which are frequently found in clean rooms.

According to a preferred embodiment, the mop holder or the mop system is heat-resistant up to 140° and resistant to cleaning and/or disinfectants and/or solvents, in some cases selected from a group consisting of surfactants, acids, bases, bleaching agents, enzymes, alcoholic solutions and any mixtures thereof.

According to a further aspect of the disclosure, a method for producing a flat mop cover is provided. The method can be designed in particular for producing an above-described flat mop cover. In the method according to the disclosure,
(a) a material web is provided and conveyed in the longitudinal direction;
(b) opposite longitudinal sides of the material web are folded over to form longitudinal pockets;
(c) in each case at least one connection, in some cases layer connection, such as a point seam, a transverse seam and/or a longitudinal seam, is introduced into the material web in order to fix the longitudinal pockets; and
(d) a flat mop cover is separated from the material web in the longitudinal direction, in some cases at a predetermined length, wherein, during the separation, a loose transverse edge is formed at a front end of the material web in the longitudinal direction and a loose transverse edge is formed at a rear end of the flat mop cover in the longitudinal direction.

A material web, in some cases a textile material web, can be realized by a substantially two-dimensional, web-shaped material. The web-shaped material is distinguished in that its extent in the longitudinal direction of the material web is substantially, i.e., at least by the factor 10, in some cases by the factor 100, preferably by the factor 1000 or more, greater than its extent in a transverse direction transversely, preferably perpendicularly, to the longitudinal direction. The extent in the transverse direction is substantially greater than the extent in the thickness direction of the material web. The material web can be provided, for example, rolled up onto a roll, a drum or the like. Alternatively or additionally, the material web or a part of the material web can be provided by a continuous feed, in some cases from a material web (part) production plant, such as an extrusion plant. The material web is preferably multi-layered and comprises at least one cover layer and a cleaning layer as well as optionally an intermediate layer which is arranged between the cover layer and the cleaning layer. Preferably, the material web comprises cover and cleaning layers of the same width in the transverse direction. In some cases, the intermediate layer is narrower in the transverse direction than the cover and cleaning layer. The material of the cover layer, the material of the cleaning layer and/or the material of the intermediate layer can be selected as described above with respect to the mop cover. It should be clear that different material layers of the material web are provided starting from corresponding different initial webs. It can be preferred that a material web or material web layer, respectively, is provided for a mop cover by being divided in the longitudinal direction from a wider initial web. Several, in some cases three or five, material webs or material web layers, respectively, can be divided from the initial web so that several production methods can be carried out starting from the same initial web in parallel and/or next to one another. An initial web can have, for example, a width of about 150 cm, wherein three material webs or material web layers, respectively, of substantially the same width are provided by dividing from the initial web. The dividing of at least one material web or material web layer from the initial web preferably takes place by thermal dividing.

The predetermined length of a flat mop cover, after which the separation of a flat mop cover from the material web takes place, can be at least 30 cm, preferably at least 40 cm, and/or no more than 60 cm, preferably no more than 50 cm, in some cases about 48 cm. The transverse width of the material web from one longitudinal side edge to the other opposite longitudinal side edge can be at least 15 cm, in some cases at least 18 cm, and/or no more than 30 cm, preferably no more than 20 cm, in some cases about 19 cm. The opposite longitudinal pockets can be formed with a transverse width in the range of at least 10 mm, preferably at least 20 mm, and/or no more than 40 mm, preferably no more than 30 mm, in some cases about 25 mm. By manufacturing a flat mop cover with opposite longitudinal pockets in the transverse direction from a material web, a large number of flat mop covers can be provided particularly economically.

In one embodiment of a production method, the introduction of the at least one connection, in some cases layer connection, comprises forming at least one longitudinal seam along a longitudinal edge, preferably in each case one longitudinal seam at both longitudinal edges. The longitudinal edge is preferably introduced after folding over at least one longitudinal side edge of the material web to form longitudinal pockets, such that the longitudinal seam fixes and stabilizes the longitudinal pocket at least in sections, in some cases along its entire longitudinal extent. The at least one longitudinal seam can preferably be formed in the region of the leading end of the material web before a flat mop cover of predetermined length is separated from the material web.

Alternatively or additionally, according to one embodiment of the production method, the introduction of the at least one connection, in some cases of the layer connection, can comprise introducing at least one bar which divides a pocket in the longitudinal direction into several sections. The at least one bar can preferably be introduced in the region of the leading end of the material web after folding over at least one longitudinal side edge before a flat mop cover of predetermined length is separated from the material web. It can be preferred that bars opposite one another in the transverse direction are introduced into the material web simultaneously in the same or in two directly successive production steps.

Further alternatively or additionally, in one embodiment of the production method, the introduction of the at least one connection can comprise introducing a transverse connection, in some cases a transverse seam, at the front end of the material web, in some cases at a predetermined distance from the front end of the material web. The transverse connection can extend at least in sections transversely over the width of the pockets or continuously over the entire transverse width of the material web, in some cases with folded-over longitudinal side edges.

According to a further development of the production method, the introduction of the at least one connection comprises introducing a second transverse connection, in some cases a second transverse seam, into the material web, in some cases at the transverse edge opposite the first transverse connection, wherein the second transverse connection is introduced at the rear end of the flat mop cover to be formed, at a predetermined distance from the rear end of the flat mop cover which is formed during the subsequent separation of the flat mop cover from the material web. Additionally or alternatively, a layer connection which connects the flap or pocket to the active surface can be introduced at the transverse edge, in some cases between the transverse edge and the (adjacent) transverse seam corresponding thereto, and/or an, in some cases textile ribbon can be provided, by way of which the opposite flaps or pockets are connected to one another, wherein the ribbon is preferably fastened to the inner side.

In one embodiment of the production method, the separation of the flat mop cover from the material web is carried out by thermal cutting, in some cases by way of a heat, laser and/or ultrasonic cut. The thermal cutting can preferably be used in combination with the previous introduction of at least one or precisely one intermediate layer between the cover layer and the cleaning layer in order to connect the intermediate layer to the cover layer and/or the cleaning layer, in some cases in a material-locking manner, by way of the thermal action. By separating the flat mop cover from the material web by thermal cutting, the textile material or textile materials which form the material web can be sealed along its cutting edges at the transverse edge. The handling of the flat mop cover is thereby improved and it is ensured that no cut residual particles are introduced into a clean room with the flat mop cover.

In another embodiment of the production method, which can be combined with the previous one, the provision of the material web comprises the material web being formed from exactly two or at least two different layers. The layers preferably comprise a cleaning layer and a cover sheet layer, wherein in some cases the folding over of the longitudinal side edges of the material web is configured in such a way that the cover sheet layer is folded over or folded over inwards. Optionally, the material web is formed with at least one intermediate layer which is arranged between the cleaning layer and the cover sheet layer in the thickness direction of the material web. When providing the material web from different layers, the layers are connected, in some cases sewn together, at least at points to one another in the longitudinal direction, wherein preferably a fixing, such as a bar, is formed which is adapted and arranged for fixing a defined position of the mop cover relative to a flat mop holder, in some cases with a receptacle formed complementarily to the fixing. The connection of at least two, preferably all, layers of a multi-layer material web preferably takes place before folding over the longitudinal side edges of the material web.

Alternatively or additionally, it can be provided that the provision of the material web comprises the material web being formed from at least three different layers, in some cases exactly 3 different layers, wherein the three different layers comprise a cleaning layer which is in some cases adapted and arranged to be brought into contact with a surface to be cleaned, and a cover sheet layer which is in some cases adapted and arranged to be brought into contact with a flat mop holder. The three different layers further comprise an intermediate layer. The intermediate layer can have a water pick-up capacity of at least 10 ml/g, in some cases at least 16 ml/g, preferably at least 22 ml/g. Alternatively or in some cases additionally, the intermediate layer can be formed from an unconsolidated nonwoven material or a needle nonwoven material, in some cases with a grammage of 240 g/m², or from a foam material, preferably a needle nonwoven material. The nonwoven material for forming the intermediate layer preferably has a thickness in the unloaded state of at least 3 mm, in some cases at least 5 mm, preferably at least 7 mm and/or not more than 25.4 mm, in some cases not more than 13 mm, preferably not more than 10 mm.

According to one embodiment of a production method, which can be combined with the previous ones, the cover sheet layer can further be consolidated from a nonwoven material under the action of heat. The consolidation of the cover sheet layer is preferably carried out before the connection of the cover sheet layer to a cleaning layer. The consolidation of the cover sheet layer is preferably carried out without exerting mechanical pressure on the cover sheet layer.

The disclosure also relates to a kit of parts which comprises a flat mop holder described above or a mop system described above and at least one or more flat mop covers which are formed and/or manufactured as described above.

According to the disclosure, the use of the flat mop holder described above or the mop system described above and/or at least one flat mop cover which is manufactured and/or formed as described above is provided for the cleaning, in particular of floors, walls and/or ceilings, in preferably sterile clean rooms.

### BRIEF DESCRIPTION OF THE SEVERAL VIEWS OF THE DRAWINGS

Further features and advantages of the present disclosure result from the following description, in which preferred embodiments of the present disclosure are explained by way of example with reference to schematic drawings. In the drawings:

FIG. 1 shows a perspective view of a mop system according to a first embodiment with a flat mop cover;

FIG. 2 shows a schematic plan view on a flat mop cover;

FIG. 3 shows a schematic side view of a two-layer flat mop cover;

FIG. 4 shows a schematic side view of a three-layer flat mop cover;

FIG. 5 shows a perspective view of another mop system;

FIG. 6 shows a perspective view of a further mop system;

FIG. 7a shows a plan view on a mop holder according to FIG. 6;

FIG. 7b shows a perspective view of the mop holder according to FIG. 7a;

FIG. 7c shows a perspective sectional view through the pivot joint of the mop holder according to section line C-C in FIG. 7a;

FIG. 8 shows a schematic plan view on another flat mop cover; and

FIG. 9 shows a schematic plan view on a further flat mop cover.

In the following description of various preferred embodiments with reference to the accompanying figures, the same or similar reference signs are used for easier readability for the same or similar components.

### DETAILED DESCRIPTION

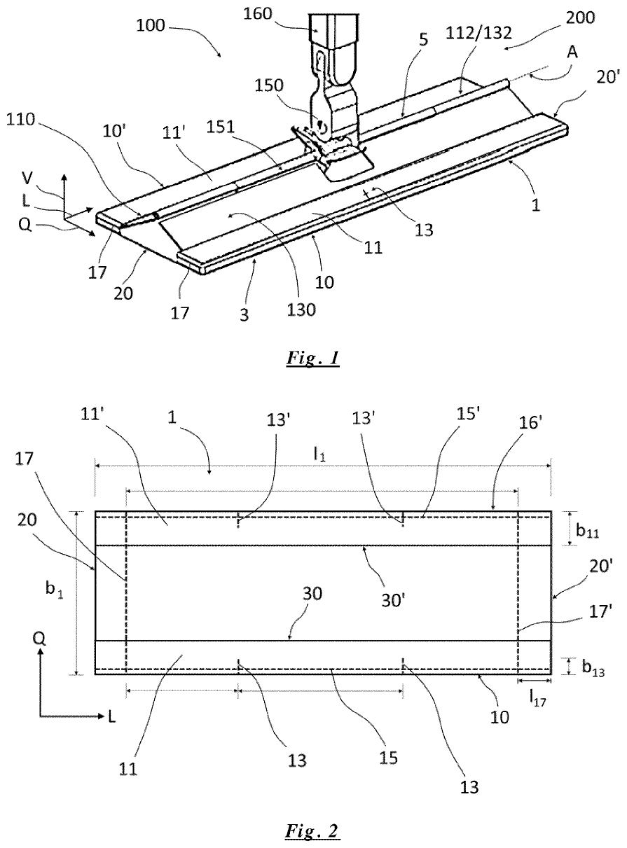

FIG. 1 shows a flat mop cover 1 in combination with a mop system 200, which comprises a flat mop holder 100, which is connected to a mop handle 160 via a connecting piece 150. The connecting piece 150 comprises a pivot-tilt joint, which makes it possible to arrange the elongate mop handle 160 relative to the flat mop holder 100 at different pivot and tilt angles. The connecting piece 150 is arranged on the upper side 105 of the flat mop holder 100. The lower side 103 of the flat mop holder 100 is directed towards a wiping or active surface 3 of the flat mop cover 1. The rear side 5 of the flat mop cover is directed away from the surface to be cleaned.

The flat mop cover 1 is realized as a textile part with a substantially rectangular cross section with longitudinal edges 10, 10′ and transverse edges 20, 20′ lying opposite one another in each case in pairs. The transverse edges 20, 20′ are substantially shorter than the longitudinal edges 10, 10′. The flat mop cover 1 has pockets 11, 11′ lying opposite one another in the transverse direction Q along the longitudinal edges 10, 10′. The pockets 11, 11′ extend in the longitudinal direction L over virtually the entire longitudinal extent 1 1 of the mop cover 1. In the embodiment of a flat mop cover 1 illustrated in FIG. 1, a bar 13 realized as a point seam is formed centrally in the longitudinal direction L, which bar extends in the thickness direction through the first pocket 11 of the flat mop cover 1 and divides the pocket 11 into two sections, which can be referred to for example as the right pocket section and the left pocket section. A point seam is formed by a multiplicity of stitches, in some cases at least 10 or at least 20, in a point region with an area of no more than 4×4 mm, in some cases no more than 2×2 mm.

The mop holding wing 100 has two mop holding wings 110, 130, which are both mounted on the connecting piece 150 so as to be pivotable about a pivot axis A. FIG. 1 shows the flat mop holder 100 in a release position, in which the mop holding wings 110, 130 lying opposite one another in the transverse direction Q are angled relative to one another. The mop holding wings 110, 130 have inner longitudinal edges 112, 132, which are in touch contact with one another in the embodiment illustrated in FIG. 1 and on which a pivot joint 151 is formed, which allows the mop holding wings 110, 130 to be movable in rotation relative to one another. Spaced apart from the inner longitudinal edges in the transverse direction Q, the mop holding wings 110, 130 have outer longitudinal edges (not illustrated in more detail), which are inserted into corresponding pockets 11, 11′ of the flat mop cover 1.

In the release position of the flat mop holder 100, a used flat mop cover 1 can slide down from the flat mop holder 100 by the own weight of the flat mop cover 1 and the action of gravity. In the release position, the mop holding wings 110, 130 can be inserted into pockets 11, 11′ of a fresh flat mop cover 1 lying opposite one another.

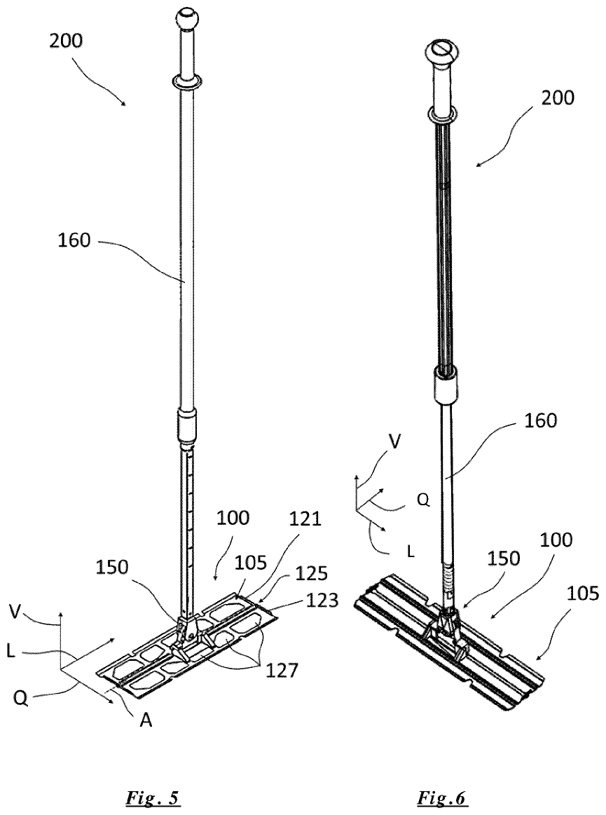

After the insertion of the mop holding wings 110, 130 into the pockets 11, 11′ of the mop cover, the flat mop holder can be brought into an operating position. In the operating position, the mop holding wings 110, 130 of the flat mop holder 100 are arranged in a common plane, as shown for example in FIGS. 5 and 6, which are described in detail below. In order to hold the flat mop holder 100 securely in the operating position for cleaning, the flat mop holder 100 can be equipped with a locking mechanism not illustrated in more detail.

For example, the locking mechanism can comprise a magnetic holding part which is accommodated movably in the connecting piece. The magnetic holding part can be movable for example relative to the mop holding wings 110, 130 in a vertical direction V transversely to the longitudinal and transverse direction L, Q. The magnetic holding part can be arranged in a locking position, in which, in the operating position of the flat mop holder 1, a magnetic force fit is closed with a corresponding magnetizable or magnetic holding partner held in a stationary manner on a mop holding wing 110, 130, which is rigidly fastened to a mop holding wing 110, 130. The magnetic holding part can be brought into a release position, in which the magnetic force fit is released, so that the holding wing or wings 110, 130 are forced into the release position by the own weight or optionally a preload.

The mop holder 100 has a receptacle (not illustrated in detail) which is adapted and arranged to be brought into engagement with the bar 13 of the mop cover 1 in the operating position of the flat mop holder 100. When the bar 13 of the mop cover 1 is brought into engagement with the corresponding receptacle of the flat mop holder 100, the position of the flat mop cover 1 relative to the flat mop holder 100 is thereby fixed. As a result of the engagement pairing of the bar 13 with the corresponding receptacle of the flat mop holder 100, the flat mop cover 1 is secured against slipping in the longitudinal direction L and in some cases against sliding off the flat mop holder 100 in the vertical direction V.

FIG. 2 shows an exemplary embodiment of a flat mop cover 1. The flat mop cover 1 has a substantially rectangular basic shape. The transverse edges 20, 20′ lying opposite one another define a transverse width b 1 of the mop cover 1 which is smaller than its longitudinal extent 1 1 defined by the longitudinal edges 10, 10′ lying opposite one another. For example, the transverse width b1 can be approximately 145 mm and the longitudinal extent 11 can be approximately 480 mm.

The flat mop cover 1 has two longitudinal seams 15, 15′ arranged along its longitudinal edges 10, 10′ at a small distance of a few millimeters from the respective longitudinal edge 10, 10′ and extending parallel to the respective longitudinal edge. The longitudinal seams 15, 15′ are realized by seams which extend in the vertical direction V or thickness direction, respectively, transversely through the pocket 11, 11′ formed along the respective longitudinal edge 10, 10′. The pocket 11, 11′ extends from the respective longitudinal edge 10, 10′ by a pocket width b11 of a few centimeters, for example approximately 25 mm, in the transverse direction Q.

At the transverse edges 20, 20′ lying opposite one another, transverse connections 17, 17′ are provided which, as depicted here, can extend for example over the entire transverse width b1 of the flat mop cover 1 from a first longitudinal edge 10 to the opposite second longitudinal edge 10′. The transverse connections 17, 17′ can be formed, for example, by transverse seams. Alternatively, one or both transverse connections 17, 17′ can be formed by several point connections, in some cases point seams, arranged in a row. The transverse connections 17, 17′ are arranged at a distance from the respective closest transverse edge 20, 20′ and extend parallel to this transverse edge 20, 20′. The longitudinal distance 117 of a transverse connection 17, 17′ from the respective transverse edge 20, 20′ can be a few centimeters, for example approximately 15 mm. The transverse connections 17, 17′ lying opposite one another in the longitudinal direction L preferably do not delimit the pockets 11, 11′ in the longitudinal direction L.

In the embodiment depicted in FIG. 2, bars 13, 13′ are provided in the longitudinal direction L centrally between the opposite transverse edges 20, 20′ along both longitudinal edges 10, 10′, which extend inwards in the transverse direction Q starting from the respective longitudinal edge 10, 10′. The bar width b13 in the transverse direction Q is smaller than or equal to the pocket width b11 and can be around 1 cm, for example 12 mm. According to an alternative not illustrated in more detail, instead of an elongate seam, a point seam can be provided as a bar 13, which is arranged at a transverse distance from the respective longitudinal edge 11, 11′ corresponding to the described bar width b13. The bars 13 are arranged mirror-symmetrically in each case in pairs on the flat mop cover 1 both with respect to a longitudinal central axis and with respect to a transverse central axis.

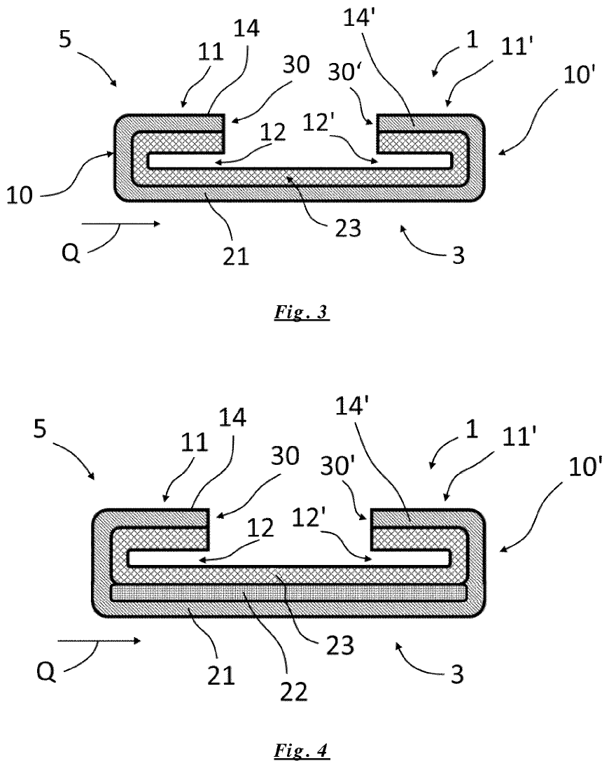

FIGS. 3 and 4 show schematic cross-sectional views of exemplary multi-layer flat mop covers 1 or multi-layer material webs prepared to form flat mop covers 1. In the cross-sectional views according to FIGS. 3 and 4, the longitudinal direction L of the flat mop cover 1 extends into the sheet in the viewing direction. In order to simplify readability, no seams or other connections are illustrated in FIGS. 3 and 4.

FIG. 3 shows a two-layer flat mop cover 1, which is composed of a cleaning layer 21 and a cover sheet layer 23. The flat mop cover according to FIG. 4 differs from the embodiment illustrated in FIG. 3 in that, in addition to the cleaning layer 21 and cover sheet layer 23, it comprises an intermediate layer 22 arranged between these two. It should be clear that, corresponding to the intermediate layer 22, one or more further intermediate layers (not illustrated in more detail) can be arranged between the cover sheet layer 23 and the cleaning layer 21.

The cleaning layer 21 is formed as an unconsolidated textile material which is adapted and arranged for receiving a cleaning liquid and dirt particles. The cover sheet layer 23 is formed as a consolidated nonwoven material which, in order to simplify its handling, equips the flat mop cover 1 with a certain mechanical rigidity and which is resistant to damage by friction with a flat mop holder 100 which is or can be inserted into the pockets 11, 11′. For some applications, it may be desirable to increase the water pick-up capacity of a flat mop holder 1. For this purpose, an intermediate layer 22 can be provided which can be formed from an unfastened textile material, in some cases an unconsolidated nonwoven material, or a foam material.

The flat mop cover I can be formed, for example, starting from a web-shaped initial material. For this purpose, the material web can be conveyed along a longitudinal direction which corresponds to the longitudinal direction 1 of the flat mop cover 1 to be manufactured. In the transverse direction Q, the material web is delimited on both sides by opposite longitudinal side edges 30, 30′ which define a material web transverse width. The material web transverse width can be, for example, approximately 20 cm.

To form a flat mop cover 1, the material web can be folded over along the opposite longitudinal side edges 30, 30′ inwards, towards the cover sheet layer 23, so that the material web forms opposite flaps 14, 14′ in the transverse direction Q on the upper side or rear side 5 of the flat mop cover, from which longitudinal pockets 11, 11′ are formed in the further production method. The inner sides 12, 12′ of the longitudinal pockets 11, 11′ are formed by the cover sheet layer 23. In order to fix the flaps, connections, for example the longitudinal seams 15, 15′ described above with respect to FIG. 2, can be introduced into the flat mop cover 1. The longitudinal seams can be realized as a connecting seam which penetrates the plurality of layers of the flat mop cover. In the case of multi-layer flat mop covers, a problem can be that the different layers slip relative to one another. In some cases, the intermediate layer can slip relative to the cover layer and/or to the cleaning layer. The connecting seams fix the layers relative to one another. In order to form the longitudinal pockets 11, 11′ from the flaps 14, 14′, transverse connections spaced apart from one another in the longitudinal direction L are provided, such as the above-described transverse seams 17, 17′, which are formed in the region of the flaps 14, 14′ and/or of the active surface.

In addition, a bar 13 or several bars 13, 13′ can be formed in the longitudinal direction L between the transverse connections 17, 17′ on at least one of the two mutually opposite longitudinal pockets 11, 11′, which bar divides the respective longitudinal pocket 11, 11′ into different sections in the longitudinal direction L. For example, the flat mop cover 1 according to FIG. 2 has a central pocket section, which extends in the longitudinal direction L between the two bars 13 adjacent to the longitudinal edge 10. And a right pocket section and a left pocket section on the regions of the pocket 11 adjacent to the central pocket section in the longitudinal direction L. The first and/or second longitudinal pocket 11, 11′ can be manufactured without a bar, as shown for example in FIG. 1.

After the introduction of connections formed in some cases as seams, a finished flat mop cover I can be separated from the material web conveyed in the longitudinal direction. The flat mop cover 1 is separated for example by thermal cutting, for example by way of an ultrasonic cut or a laser cut, so that, during the separation of the flat mop cover 1, the front transverse edge of the material web (which later forms a front transverse edge 20 of the following flat mop cover) and the rear transverse edge 20′ of the flat mop cover 1 are directly sealed. Thermal cutting can be preferred with regard to the cleanroom suitability in order to avoid textile breakage associated with mechanical cutting and a subsequent particle release.

In the mop cover 1 depicted in FIG. 4, the intermediate layer 22 does not extend into the flaps 14, 14′. The flaps 14, 14′ are completely free of the intermediate layer. The intermediate layer 22 is arranged between the cleaning layer 21 and the cover sheet layer 23 exclusively on the active surface 3. No intermediate layer 22 is arranged on the rear side 5 of the flat mop cover in the region between the flap 14, 14′ between the cover layer 23 and the cleaning layer 21. By providing the intermediate layer 22 between the cleaning layer 21 and the cover layer 23 only in the region of the active surface 3, the cleaning effect can be improved by way of the intermediate layer without the stackability of the mop covers 1 being impaired and with avoidance of unnecessary material consumption. Furthermore, the integrity of the intermediate layer is less impaired if no seam piercings of the intermediate layer take place in the region of the flap 14, 14′, as a result of which the particle release is reduced, which is advantageous with regard to use in the clean room.

The intermediate layer 22 can be formed from a single-layered needle nonwoven which has a grammage of about 240 g/m², a water pick-up capacity of more than 22 ml/g and a water release capacity of more than 20 ml/g. The intermediate layer 22 can pick-up a water mass of at least 2200% in relation to its own weight (reference: distilled water). With a mop cover configured according to FIGS. 2 and 4, a surface coverage of 35 m² and more can be achieved compared to conventional systems, which corresponds to an increase by 100% or more compared to conventional mop covers.

Various embodiments of mop systems 200 are illustrated in FIGS. 5 and 6. The mop systems 200 each have a telescopic mop handle 160, which can be equipped with grip sections for gripping by the cleaning personnel. Provided at the lower end of the mop handle 160 in the vertical direction V is a connecting piece 150, by way of which the mop handle 160 is connected movably, for example by way of a pivot-tilt joint, to a flat mop holder 100.

FIG. 5 illustrates a mop system 200 with a flat mop holder 100, which is composed of two holding wings 110, 130, which can be formed, for example, from stainless steel. The holding wings 110 and 130 have a plurality of recesses 127 (here: 5 in each case), by way of which the weight of the flat mop holder 100 is minimized.

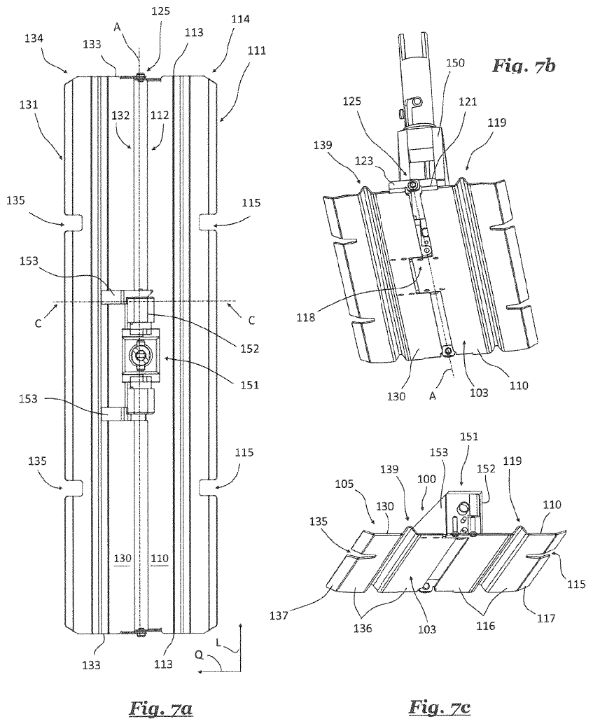

FIG. 6 illustrates a mop system 200 with another flat mop holder 100, which is described in detail below with reference to FIGS. 7a to 7c. The flat mop holder 100 can be formed predominantly from a fiber-reinforced plastic material, in some cases a carbon fiber-reinforced plastic material. The rectangular surface spanned by the flat mop holder 100 can consist predominantly, i.e., to an extent of at least 60%, in some cases at least 70%, or even 85% or more, of the plastic material in the embodiment illustrated. The flat mop holders 100 of the mop systems 200 according to the embodiments in FIGS. 5 and 6 differ from one another substantially only by the material of the respective flat mop holder 100.

The flat mop holder 100 of the mop system 200 according to FIG. 6 is illustrated in various views in FIGS. 7a-7c. FIG. 7a shows a plan view on the flat mop holder 100. The flat mop holder 100 comprises two mop holding wings 110 and 130 lying opposite one another in the transverse direction Q. The mop holding wings 110 and 130 have in each case an outer longitudinal edge 111, 131 and in each case an inner longitudinal edge 112, 132. The inner longitudinal edges 112, 132 face towards one another and are arranged closer to the pivot axis A of the flat mop holder 100 than the outer longitudinal edges 113, 131.

The longitudinal edges 111, 131 and the transverse edges 113, 133 of the mop holding wings 110, 130 define a substantially rectangular base area of the mop holder 100. Rounded flattenings are provided at the corners 114, 134 of the mop holding wing, with the aid of which the mop holding wings 110, 130 can be easily inserted into corresponding pockets 11, 11′ on the rear side 5 of a mop cover 1.

The first mop holding wing 110 is firmly connected to a connecting piece 150, which has a pivot bearing 151, which permits pivoting of the second mop holding wing 130 relative to the first mop holding wing 110. The primary pivot bearing 151 comprises a base 152 which is rigidly fastened to a base portion 118 of the first mop holding wing 110. The base portion 118 projects from the inner longitudinal edge 112 of the first mop holding wing 110 in the transverse direction Q beyond the pivot axis A and is accommodated in a complementary transverse recess along the inner longitudinal edge 132 of the second mop holding wing 130.

Furthermore, the primary pivot bearing 151 comprises two wedges 153 lying opposite one another in the longitudinal direction L on the base 152, which wedges are rigidly connected to the second mop holding wing 130. The wedges 153 are mounted on the base 152 so as to be rotatable about the pivot axis A. In the operating position of the flat mop holder 100 illustrated for example in FIG. 6 and FIG. 7b, the mop holding wings 110, 130 extend substantially coplanar with respect to one another in order to clamp a flat mop cover (not depicted). The pivot bearing 151 has a releasable locking mechanism, not illustrated in more detail, by way of which the flat mop holder 100 is held in an operating position.

The releasable locking mechanism can be formed, for example, by a locking pin which is mounted so as to be movable in a translatory manner parallel to the pivot axis A in the longitudinal direction L and which, in the operating position, assumes a locking position in which the locking pin engages in a locking receptacle of complementary shape in at least one of the wedges 153 in order to form a form-fitting locking mechanism. When the locking pin is removed from the locking position, the form-fitting locking mechanism is released, so that the wedge 153 and the mop holding wing 130 fastened thereto are rotatable about the pivot axis A.

The wedge 153 is supported on the base 152 in the transverse direction Q in the operating position. On the second mop holding wing 130, the wedge 153 extends in the transverse direction over a transverse width which is at least one quarter, preferably approximately one third to approximately one half, of the wing width. A good introduction of force from the mop handle 160 through the connecting piece 150 into the second mop holding wing 130 can thereby be ensured. In the operating position, the wedge 153 can preferably extend from the base 152 as far as a longitudinal rib 139 of the mop holding wing 130.

The mop holding wings 110, 130 can have one or more longitudinal ribs 119, 139 centrally in the transverse direction, which extend in the direction of the upper side 105 of the flat mop holder 100. Additionally or alternatively, a mop holding wing 110, 130 can have substantially planar, preferably substantially coplanar, flat sections 116, 136 with respect to one another. The longitudinal rib 119, 139 preferably extends starting from a flat section 116, 136 in the direction of the upper side 105. As can be seen in FIG. 7b, the longitudinal rib can be formed as a curvature of the mop holding wing 110, 130 projecting convexly in the vertical direction V, which curvature extends parallel to the pivot axis A or longitudinal direction L, respectively.

Elevations projecting in the direction of the upper side 105 are provided on the two opposite transverse edges 113, 133 of the mop holding wings 110, 130 in the longitudinal direction L, which elevations are realized as transverse ribs 121, 123. The transverse ribs 121, 123 are connected by way of a hinge 125, which is rotatable about the pivot axis A. The hinge 125 forms a respective secondary pivot bearing, which cooperates with the primary pivot bearing 151 in order to define the rotational mobility of the second mop holding wing 130 relative to the first mop holding wing 110 about the pivot axis A. Arranging the additional secondary pivot bearings 125 increases the stiffness of the mop holder 1.

Recesses 115, 135 are introduced into the longitudinal edges 111, 113 centrally in the longitudinal direction between the opposite transverse edges 113, which recesses extend in the transverse direction Q from the longitudinal edge 111, 131 transversely into the solid material of the mop holding wing 110, 130. It can be preferred that the length of a mop holding wing 110, 130 is dimensioned correspondingly to the longitudinal extent of a pocket 11, 11′. The receptacles 115, 135 are adapted and arranged to receive corresponding fixings of a flat mop cover, such as the above-described bars 13, 13′. The arrangement of the fixings on the mop cover side and the arrangement of the recesses on the mop holder side are preferably coordinated with one another. In some cases, the number of fixings and recesses can be coordinated with one another in a mop cover-mop holder combination. The receptacles 115, 135 are arranged mirror-symmetrically in pairs with respect to a longitudinal central axis and with respect to a transverse central axis of the mop holder.

With the aid of an engagement pairing of a fixing of a flat mop cover 1 in a corresponding receptacle 115 or 135 of a flat mop holder 100, the position of the flat mop cover relative to the flat mop holder can be fixed and secured. In the operating position, the holding wings 110, 130 hold the flat mop cover in a form-fitting manner on the mop system 200, wherein the form fit is reinforced by the mutually engaging toothing of bar and recess 115, 135.

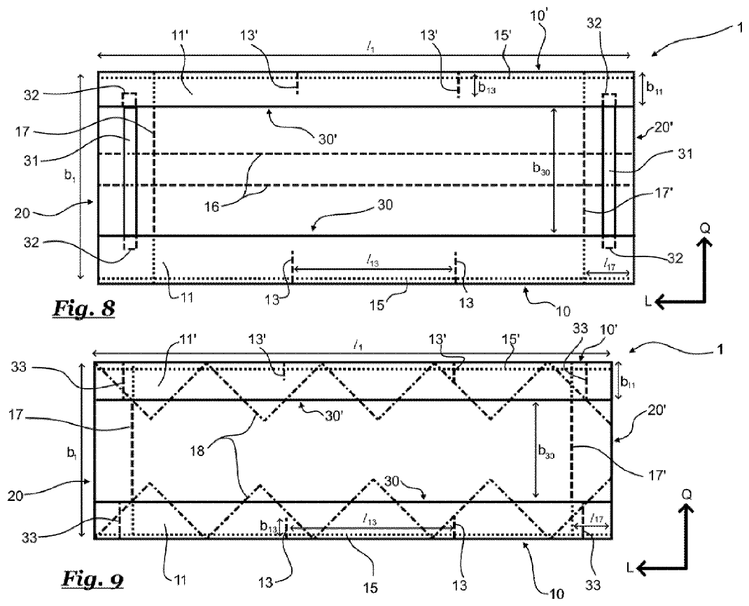

FIGS. 8 and 9 show further embodiments of flat mop covers 1. In order to avoid repetitions, reference is made substantially to the above embodiments relating to FIG. 2. The bar distance 113 in the longitudinal direction between the two bars 13 or 13′ is between one third and two thirds of the longitudinal extent 11 of the flat mop cover 1. For example, in the case of a flat mop cover with a longitudinal extent 11 of approximately 480 mm, a bar distance 113 of approximately 200 mm can be provided.

Transverse connections 17, 17′ are provided on the transverse edges 20, 20′. The transverse connections 17 (or 17′) are arranged substantially parallel at a transverse connection distance 117 of 5 to 50 mm, for example 25 mm, adjacent to the respective corresponding transverse edge 20 (or 20′). The transverse connections 17, 17′ preferably penetrate the preferably multi-layer flat mop cover 1 only once; i.e., the transverse connections do not fix the pockets 11, 11′ to the active surface of the flat mop cover. Instead, pocket fixings are provided between the transverse connections 17, 17′ and the respective adjacent transverse edge 20, 20′.

In FIG. 8, the pocket fixing is formed by a textile ribbon 31 which connects the opposite flaps 14, 14′ to one another. The ribbons 31 are fastened in the inner region of the pockets 11, 11′, for example sewn on by way of ribbon seams 32 or another fastening, such as welding. In FIG. 9, the pocket fixing is formed by a flap bar 33. The flap bar 33 fastens the flap upper side 14, 14′ to the active surface of the flat mop cover. The pocket fixings illustrated in FIGS. 8 and 9 can optionally be combined with one another. In the transverse direction Q, the flap bar 33 extends over at least half or the entire transverse width of the flap or pocket b11, respectively. The flap bar 33 can be formed, like the bar 13, 13′, as a linear seam, point seam, point seams, welding or the like.

For fastening the plurality of layers of the multi-layer flat mop cover 1, for example realized as described above with reference to FIG. 3 or 4, to one another, connecting seams 16 and/or 18 are provided, as described below with reference to FIG. 8 or 9. It should be clear that the rectilinear connecting seams 16 can be combined with the zigzag-shaped or other oblique or wave-shaped connecting seams 18. It should further be clear that the connecting seams 16, 18 can be combined as desired with the pocket fixings. The combinations depicted are preferred.

In all described embodiments of the flat mop covers according to FIGS. 2, 8 and 9, longitudinal seams 15, 15′ are provided. The longitudinal seams 15, 15′ are preferably provided as connecting seams which penetrate the plurality of layers and connect them to one another. The longitudinal seams 15, 15′ can promote crease-like the folding in of the flaps 14, 14′ or pockets 11, 11′, respectively.

In FIG. 8, two rectilinear connecting seams 16 arranged in the central region of the flat mop cover 1 are provided. The central region extends between the opposite longitudinal side edges 30, 30′. The distance of the longitudinal side edges 30, 30′ or the central region width b30 is approximately half to two thirds of the flat mop cover transverse width b1. For example, in the case of a transverse width b1 of approximately 12 cm, the central region width b30 can be approximately 7 cm. The distance of the rectilinear connecting seams 16 is less than the distance of the longitudinal side edges 30, 30′ and can preferably be coordinated with the flat mop holder in such a way that the distance of the longitudinal edges of the mop holding wings in the release position is always greater than the distance of the rectilinear connecting seams 16.

Alternatively, as illustrated in FIG. 9, for example zigzag-shaped, oblique connecting seams 18 could be provided. The oblique connecting seams extend from the longitudinal edge 10, 10′ beyond the longitudinal side edges 30, 30′ into the central region of the flat mop cover. As depicted, the inclination can be approximately 45° with respect to the longitudinal direction L. Preferably, in some cases mirror-symmetrically opposite zigzag-shaped or otherwise at least in sections oblique connecting seams 18 are provided on both longitudinal side edges 10, 10′ of the flat mop cover 1. Preferably, the oblique connecting seams do not extend over a transverse center line of the flat mop cover, particularly preferably do not extend as far as the transverse center line (not depicted). The oblique connecting seams 18 preferably begin in at least two corners of the flat mop cover (as depicted on the left), in some cases in all four corners of the flat mop cover. Alternatively, the oblique connecting seams 18 leave at least two corners of the flat mop cover free (as depicted on the right) or even leave all four corners of the flat mop cover free. It should be clear that the zigzag-shaped connecting seams preferably penetrate only the active surface, in some cases all layers of the active surface, but not the rear-side pockets 11 of the flat mop cover 1. In some cases, the connecting seams 18 leave the pockets 11 free.

The features of the present disclosure disclosed in the preceding description, in the claims and in the drawings can be essential both individually and in any desired combination for the realization of the disclosure in its various embodiments.

### REFERENCE SIGNS

1 Flat mop cover
3 active side
5 rear side
10, 10′ longitudinal edge
11, 11′ pocket
12, 12′ inner side
13, 13′ bar
14, 14′ flap
15, 15′ longitudinal seam
16 rectilinear connecting seam
17, 17′ transverse connection
18 zigzag connecting seam
20, 20′ transverse edge
21 cleaning layer
22 intermediate layer
23 cover sheet layer
30, 30′ longitudinal side edge
31 ribbon
32 ribbon seam
33 flap bar
100 flat mop holder
103 lower side
105 upper side
110 first mop holding wing
130 second mop holding wing
111, 131 outer longitudinal edge
112, 132 inner longitudinal edge
113, 133 transverse edge
114, 134 corner
115, 135 recess
116, 136 flat section
117, 137 curvature
118 base portion
121, 123 transverse rib
125 hinge
119, 139 longitudinal rib
127 recess
150 connecting piece
151 pivot bearing
152 base
153 wedge
160 mop handle
200 mop system
b1 transverse width
b13 bar width
b17 transverse connection distance
b30 central region width
11 longitudinal extent
b11 pocket width
113 bar distance
A leg axis
L longitudinal direction
Q transverse direction

The various embodiments described above can be combined to provide further embodiments. All of the patents, applications, and non-patent publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A flat mop cover, comprising:
an active side to be directed onto a surface to be cleaned and a rear side opposite to the active side,
first and second transverse edges opposite one another,
first and second longitudinal edges opposite one another, wherein the first and second longitudinal edges are longer than the first and second transverse edges, and
at least two pockets on the rear side opposite one another in a transverse direction for receiving a flat mop holder, wherein the at least two pockets extend along the first and second longitudinal edges,
wherein at least one of the pockets is divided by at least one bar into at least two sections, wherein the bar is adapted and arranged for fixing a predetermined position of the flat mop cover on the flat mop holder.

2. The flat mop cover according to claim 1, wherein the at least one bar is formed as a seam.

3. The flat mop cover according to claim 1, wherein the at least one bar is arranged in a pocket of the at least two pockets centrally between the transverse edges.

4. The flat mop cover according to claim 1, wherein at least one longitudinal seam extends in a longitudinal direction along the first and/or second longitudinal edge from the first transverse edge to the second transverse edge.

5. The flat mop cover according to claim 1, wherein at least one transverse connection is formed in the transverse direction along the first and/or second transverse edge, wherein the transverse connection preferably extends continuously from the first longitudinal edge to the second longitudinal edge.

6. The flat mop cover according to claim 5, wherein the at least one transverse connection is arranged at a distance from a corresponding transverse edge of at least 5 mm.

7. The flat mop cover according to claim 1, wherein at least one of the first or second transverse edges is formed as a free edge.

8. The flat mop cover according to claim 1, wherein the flat mop cover comprises at least two layers which are connected to one another at least at points, wherein a layer connection has at least one rectilinear connecting seam in a central region with respect to the transverse direction and/or at least two connecting seams which are at least in sections oblique or wave-shaped, which extend from at least one of the first or second longitudinal edges into the central region with respect to the transverse direction.

9. The flat mop cover according to claim 1, wherein the flat mop cover comprises at least three layers which are connected to one another at least at points, including a cleaning layer adapted and arranged for cleaning a surface and a cover sheet layer which is adapted and arranged for bringing into contact with the flat mop holder, wherein the cover sheet layer forms inner sides of the pockets,
wherein the flat mop cover comprises at least one intermediate layer arranged between the cleaning layer and the cover sheet layer, wherein the at least one intermediate layer has a water pick-up capacity of at least 10 ml/g and/or wherein the at least one intermediate layer is formed from a nonwoven material or from a foam material.

10. The flat mop cover according to claim 5, wherein the at least two pockets each comprise at least one flap on the rear side of the flat mop cover, wherein the flaps are connected to the active side in a region between at least one of the transverse edges and the at least one transverse connection adjacent thereto.

11. The flat mop cover according to claim 9, wherein the cleaning layer comprises a woven, knitted, or crocheted layer, and/or comprises a microfiber material.

12. The flat mop cover according to claim 9, wherein the cover sheet layer comprises a liquid-permeable nonwoven material.

13. The flat mop cover according to claim 9, wherein the at least two layers are connected to one another by at least one layer connection which extends from the rear side to the active side, wherein the at least one layer connection penetrates the cleaning layer and/or the cover sheet layer twice in a region of at least one pocket.

14. The flat mop holder for clamping a flat mop cover according to claim 1, comprising:
an upper side on which a connecting piece is arranged or can be arranged, which is adapted and arranged to connect the flat mop holder to a mop handle, and a lower side opposite the upper side facing or being capable to be faced towards the active side of the mop cover,
a first and a second mop holding wing having two opposite transverse edges and two opposite longitudinal edges, wherein an outer longitudinal edge of at least one mop holding wing faces away from the other mop holding wing, and wherein the two opposite longitudinal edges are longer than the two opposite transverse edges,
wherein at least one of the first or second mop holding wings is movable in the transverse direction relative to the other mop holding wing, and
wherein at least one of the first or second mop holding wings has at its outer longitudinal edge at least one recess for receiving a fixing of the flat mop cover.

15. The flat mop holder according to claim 14, wherein at the outer longitudinal edge at least two recesses are arranged.

16. The flat mop holder for clamping a flat mop cover according to claim 1, comprising:
an upper side, on which a connecting piece is arranged or can be arranged, which is adapted and arranged to connect the flat mop holder to a mop handle, and a lower side opposite the upper side facing or being capable to be faced towards the active side of the mop cover,
a first mop holding wing and a second mop holding wing having two opposite transverse edges and two opposite longitudinal edges, wherein an outer longitudinal edge of at least one of the first or second mop holding wing faces away from the other mop holding wing, and wherein the two opposite longitudinal edges are longer than the two opposite transverse edges,
wherein at least one of the first or second mop holding wing is movable in transverse direction relative to the other mop holding wing, and
wherein at least one holding wing of the first or second mop holding wings has on the upper side at least one reinforcing structure, which is adapted and arranged to adjust a stiffness of the at least one holding wing.

17. The flat mop holder according to claim 16, wherein the at least one reinforcing structure has a curvature inclined along the outer longitudinal edge of the at least one holding wing towards the upper side, wherein at least one recess extends in transverse direction through the curvature into a flat section of the at least one holding wing.

18. The flat mop holder according to claim 16, wherein at least one of the first or second mop holding wings has a reinforcing structure in the form of a longitudinal rib, wherein the longitudinal rib extends from a flat section of the at least one holding wing to the upper side.

19. The flat mop holder according to claim 16, wherein at least one of the first or second mop holding wings comprises a reinforcing structure in the form of an elevation projecting in a direction of the upper side.

20. The flat mop holder according to claim 16, wherein the first and second mop holding wings are connected to one another with a pivot joint at their inner longitudinal edges so as to be movable relative to one another in such a way that they can be pivoted about a longitudinal axis between a first position A, in which the first and second mop holding wings are oriented in a plane, and a second position B, in which the first and second mop holding wings are oriented at an angle to one another.

21. The flat mop holder according to claim 20, wherein the pivot joint comprises a base which is fastened to a base portion of the first mop holding wing,
wherein the base portion projects from the inner longitudinal edge in the transverse direction.

22. The flat mop holder according to claim 21, wherein the pivot joint is fastened to the second mop holding wing by way of at least one wedge, wherein the at least one wedge is mounted on the base so as to be rotatable about the longitudinal axis,
wherein the at least one wedge is supported on the base in the first position A in the transverse direction.

23. The flat mop holder according to claim 22, wherein a releasable locking mechanism holds the wedge in the first position A in a stationary manner relative to the base, wherein the locking mechanism comprises a positive connection and/or a magnetic connection.

24. The flat mop holder according to claim 20, wherein the first and second mop holding wings each comprise at least one reinforcing structure in the form of an elevation projecting in a direction of the upper side, which are connected by way of a hinge, which is rotatable about the longitudinal axis.

25. The flat mop holder according to claim 16, wherein at least one of the first or second mop holding wings comprises plastic.

26. The flat mop holder according to claim 16, wherein at least one of the first or second mop holding wings comprises metal.

27. The flat mop holder according to claim 16, wherein at least one of the first or second mop holding wings has at least one recess, which is completely surrounded on the mop holding wing in the transverse direction and longitudinal direction.

28. A mop system for cleaning clean rooms, comprising:
a mop holder formed according to claim 16, a mop handle, and a connecting piece which detachably connects the mop handle to the mop holder.

29. A method for producing a flat mop cover from a textile material web, wherein:
(a) providing a textile material web that is conveyed in a longitudinal direction;
(b) folding over opposite longitudinal side edges of the textile material web to form longitudinal pockets;
(c) introducing in each case at least one connection into the textile material web in order to fix the longitudinal pockets; and
(d) separating the flat mop cover from the textile material web in the longitudinal direction, wherein, during the separation, a loose transverse edge is formed at a front end of the textile material web in the longitudinal direction and a loose transverse edge is formed at a rear end of the flat mop cover in the longitudinal direction.

30. The method according to claim 29, wherein:
the introduction of the at least one connection comprises forming at least one longitudinal seam along a longitudinal edge.

31. The method according to claim 29, wherein:
the introduction of the at least one connection comprises introducing at least one bar which divides at least one of the longitudinal pockets in the longitudinal direction into sections.

32. The method according to claim 29, wherein:
the introduction of the at least one connection comprises introducing a transverse connection at the front end of the textile material web, which transverse connection delimits the respective longitudinal pocket in the longitudinal direction.

33. The method according to claim 32, wherein:
the introduction of the at least one connection further comprises introducing a second transverse connection into the textile material web, which delimits the respective longitudinal pocket in the longitudinal direction, wherein the second transverse connection is introduced at the rear end of the flat mop cover to be formed, at a predetermined distance from the rear end of the flat mop cover.

34. The method according to claim 29, wherein:
the separation of the flat mop cover from the textile material web is carried out by thermal cutting.

35. The method according to claim 29, wherein:
the provision of the textile material web comprises forming the textile material web from at least two different layers, wherein the at least two different layers are connected at least at points while forming at least one fixing in the longitudinal direction.

36. The method according to claim 29, wherein:
the provision of the textile material web comprises forming the textile material web from at least three different layers comprising a cleaning layer, a cover sheet layer, and an intermediate layer with a water pick-up capacity of at least 10 ml/g and/or with an intermediate layer made from a nonwoven material or from a foam material.

37. The method according to claim 35, wherein:
the provision of the textile material web further comprises providing a cover sheet layer made from a nonwoven material being consolidated under the action of heat.

38. A kit of parts comprising a mop system according to claim 28, including the flat mop holder and at least one flat mop cover.

39. (canceled)
